(19) United States
(12) Patent Application Publication
(10) Pub. No.: US 2025/0162634 A1
(43) Pub. Date: May 22, 2025

(54) DIRECT TO BAG PICK CARTS FOR USE AT PRODUCT STORAGE FACILITIES

(71) Applicant: Walmart Apollo, LLC, Bentonville, AR (US)

(72) Inventors: Brian C. Roth, Bentonville, AR (US); Praveenkumar Radhakrishnan, Sandy, UT (US); Kyle A. Swanson, Hollis, NH (US); William J. Fosnight, Windham, NH (US)

(21) Appl. No.: 18/957,103

(22) Filed: Nov. 22, 2024

Related U.S. Application Data
(60) Provisional application No. 63/602,225, filed on Nov. 22, 2023.

(51) Int. Cl. B62B 3/10; B62B 3/14

(52) U.S. Cl. CPC B62B 3/106; B62B 3/1472

(57) ABSTRACT

Systems and methods for transporting bags at a product storage facility include carts. The cart may include one or more levels of shelves/trays that can support one or more bags thereon. The trays/shelves may be folded up to facilitate bag placement/removal from the cart, and to facilitate storage of multiple carts in a nested configuration that saves storage space at the product storage facility. The cart may also include one or more levels of hooks for hanging the handles of the bags thereon, thereby providing a more secure storage of the bags on the cart. The cart may be transported using a robotic transport unit.

### CROSS-REFERENCE TO RELATED PATENT APPLICATIONS

This application claims the benefit of priority of U.S. Provisional Application No. 63/602,225 filed on Nov. 22, 2023, which is incorporated by reference herein in its entirety.

### TECHNICAL FIELD

This disclosure relates generally to picking product orders for customers, and more specifically, to picking items for product orders to bags for customers.

### BACKGROUND

In a typical product storage facility, during order fulfillment, products/goods are picked by an operator from a tote and placed into containers or bags and/or one or more pick carts. A typical pick cart may have one or more shelves that provide storage space for the products picked from a tote and/or for bags into which the products picked from the tote may be placed. Such pick carts typically do not have foldable shelves and the carts lack additional vertical or horizontal storage space, limiting both the size of the items and how many items can be carried at once. In addition, such carts typically do not permit the workers to hang plastic bags, so the workers may struggle to organize plastic bags on the carts or to easily place a picked product into the plastic bags and/or to keep the plastic bags with products on the carts. Thus, the workers picking products and placing the products onto the pick carts may have to spend extra time managing the items and/or the bags on the cart while picking products and placing the products into bags on the carts, resulting in longer picking times per order, possible product damage, and/or other inefficiencies.

### BRIEF DESCRIPTION OF THE DRAWINGS

Disclosed herein are embodiments of pick carts and robotic transport units. This description includes drawings, wherein:

FIG. 1 is a perspective view of an automated product storage facility including a product storage structure, mobile robots, and workstation with a bagging location in accordance with some embodiments;

FIG. 2 is a perspective view of an automated product storage facility including a product storage structure, mobile robots, and workstation with no bagging location in accordance with some embodiments;

FIG. 3 is a front perspective view of a cart in accordance with some embodiments;

FIG. 4 is a rear perspective view of the cart of FIG. 3;

FIG. 5 is a close-up perspective view of a portion of the cart of FIG. 3, showing a shelf of the cart in its horizontal position and a latch that provides support for a shelf of the cart in accordance with some embodiments;

FIG. 6 is a close-up perspective view of a portion of the cart of FIG. 3, showing the shelf of the cart being spatially separated from its supporting latch during the movement of the shelf from its horizontal position to its vertical position in accordance with some embodiments;

FIG. 7 is a close-up perspective view of a portion of the cart of FIG. 3, showing a shelf of the cart in its vertical position and the latch being received within a groove in the frame of the cart in accordance with some embodiments;

FIG. 8 is a close-up perspective view of a portion of the cart of FIG. 3, showing a downwardly-facing surface of a shelf of the cart and depicting a recess or groove that is sized and shaped to receive the latch when the shelf is in its horizontal position in accordance with some embodiments;

FIG. 9 is a perspective view of four carts as in FIG. 3 positioned in a nested configuration for storage in accordance with some embodiments;

FIG. 10 is a front perspective view of another cart in accordance with some embodiments;

FIG. 11 is a rear perspective view of the cart of FIG. 10;

FIG. 12 is a front elevational view of the cart of FIG. 10;

FIG. 13 is a side elevational view of the cart of FIG. 10;

FIG. 14 is a front perspective view of another cart in accordance with some embodiments, shown with the shelves in their horizontal positions;

FIG. 15 is the same view of the cart as in FIG. 14, but with the cart being shown with the shelves in their vertical positions;

FIG. 16 is a front perspective view of four carts as in FIG. 14 positioned in a nested configuration for storage in accordance with some embodiments;

FIG. 17 is a rear perspective view of the four nested carts shown in FIG. 16;

FIG. 18 is a front perspective view of forty-two carts as in FIG. 14 positioned in a nested configuration for storage in accordance with some embodiments;

FIG. 19 is a rear perspective view of over one hundred carts as in FIG. 14 positioned in a nested configuration for storage in accordance with some embodiments;

FIG. 20 is a front perspective view of another cart in accordance with some embodiments, shown with the shelves in their horizontal positions;

FIG. 21 is the same view as in FIG. 14, but with the cart being shown with the shelves in their vertical positions;

FIG. 22 is a front elevational view of the cart of FIG. 21;

FIG. 23 is the same view of the cart as in FIG. 20, but with the cart loaded with multiple bags having handles;

FIG. 24 is a side elevational view of the cart of FIG. 20;

FIG. 25 is a front perspective view of four carts as in FIG. 20 positioned in a nested configuration for storage in accordance with some embodiments;

FIG. 26 is a front perspective view of over one hundred carts as in FIG. 20 positioned in a nested configuration for storage in accordance with some embodiments;

FIG. 27 is perspective view of an automated product storage facility in accordance with some embodiments that includes a product storage structure, mobile robots workstations, product-transporting carts, and product pick up area that provides parking spaces for cars to which the carts may be transported;

FIG. 28 is a block diagram of a system for facilitating movement of product-containing carts as a product storage facility in accordance with some embodiments;

FIG. 29 is a functional diagram of the computer system of FIG. 28 in accordance with several embodiments.

FIG. 30 is a front perspective view of a robotic transport unit in accordance with some embodiments, shown by way of example coupled to the cart of FIG. 20;

FIG. 31 is a close-up front elevational view of the robotic transport unit of FIG. 30 when coupled to the cart;

FIG. 32 is a front perspective view of another robotic transport unit in accordance with some embodiments, shown coupled to a cart in accordance with some embodiments;

FIG. 33 is a close-up front elevational view of the robotic transport unit of FIG. 32 when coupled to the cart;

FIG. 34 is a block diagram of a robotic transport unit in accordance with some embodiments; and

FIG. 35 is a flow chart of an exemplary process of transporting a plurality of bags in a product storage facility in accordance with some embodiments.

Elements in the figures are illustrated for simplicity and clarity and have not been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Embodiments of the present technology will now be described with reference to the figures, which in general relate to pick carts, which may be used with automatic storage and retrieval system having one or more product picking workstations. As will be described in more detail below, the embodiments of the pick carts described herein enable an intuitive and efficient product picking and packing at the workstation of the automating storage and retrieval system.

It is understood that the present embodiments may be embodied in many different forms and should not be construed as being limited to the embodiments set forth herein. Rather, these embodiments are provided so that this disclosure will be thorough and complete and will fully convey the invention to those skilled in the art. Indeed, the embodiments are intended to cover alternatives, modifications and equivalents of these embodiments, which are included within the scope and spirit of the invention as defined by the appended claims. Furthermore, in the following detailed description, specific details are set forth in order to provide an understanding of the present embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the invention. Thus, appearances of the phrases “in one embodiment,” “in an embodiment,” “in some embodiments”, “in some implementations”, and similar language throughout this specification may, but do not necessarily, all refer to the same embodiment. The terms “top” and “bottom,” “upper” and “lower” and “vertical” and “horizontal” as may be used herein are by way of example and illustrative purposes only and are not meant to limit the description of the embodiments inasmuch as the referenced item can be exchanged in position and orientation.

As used herein, the terms “substantially” and/or “about” mean that the specified dimension or parameter may be varied within an acceptable manufacturing tolerance for a given application. In one non-limiting embodiment, the acceptable manufacturing tolerance is ±0.25%. For purposes of this disclosure, a connection may be a direct connection or an indirect connection (e.g., via one or more other parts). In some cases, when a first element is referred to as being connected, affixed or coupled to a second element, the first and second elements may be directly connected, affixed or coupled to each other or indirectly connected, affixed or coupled to each other. When a first element is referred to as being directly connected, affixed or coupled to a second element, then there are no intervening elements between the first and second elements (other than possibly an adhesive or weld used to connect, affix or couple the first and second elements).

Generally, this application relates to carts for transporting a plurality of bags at a product storage facility. The carts include one or more levels of shelves/trays that can support one or more bags thereon. The trays/shelves can be folded up to facilitate bag placement/removal from the cart, and to facilitate storage of multiple carts in a nested configuration that saves storage space at the product storage facility. The carts also include one or more levels of hooks for hanging the handles of the bags thereon, thereby providing a more secure storage of the bags on the cart. And in some embodiments, the cart can be transported using a robotic transport unit.

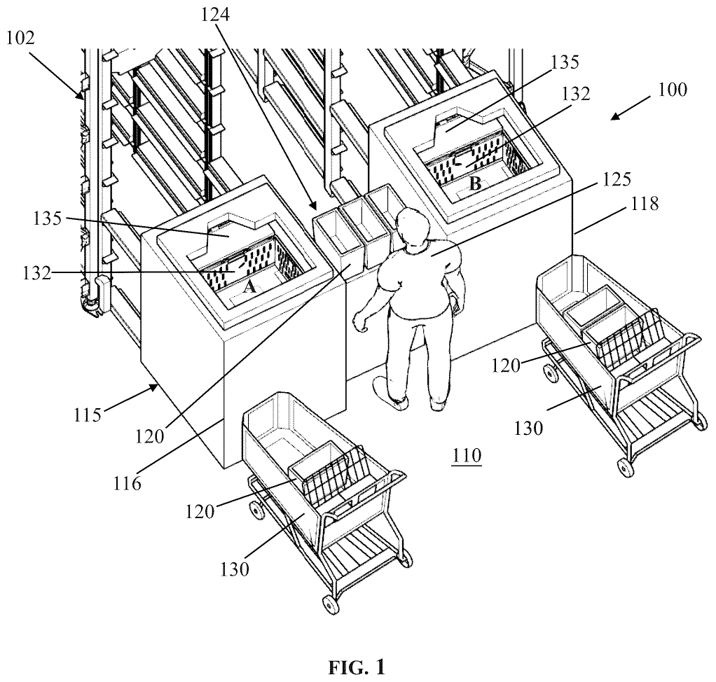

FIG. 1 shows a perspective view of an exemplary embodiment of an automated product storage facility 100 including a product storage structure 102, mobile robots 135, and a workstation 115. The exemplary workstation 115 is a workstation, where products/goods are picked (by a hand of a human operator or an arm of a robot) from totes 132 and placed into containers or bags 120 and/or one or more pick carts 130.

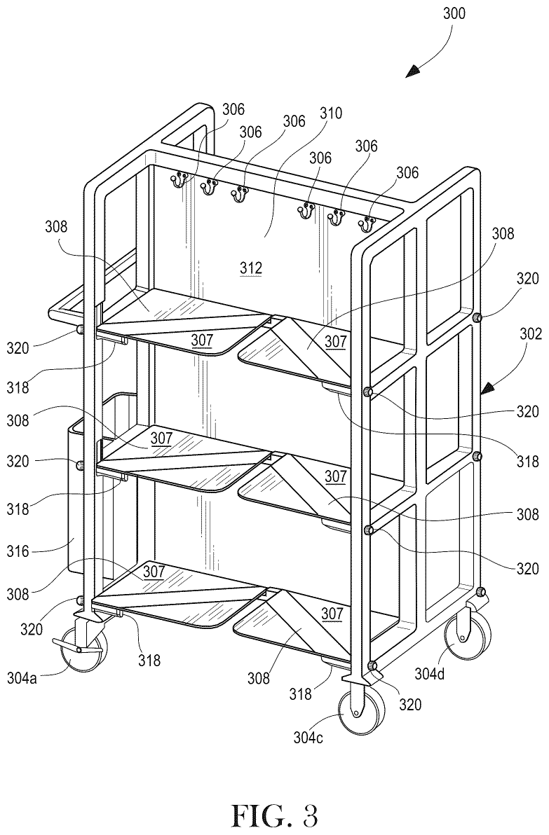

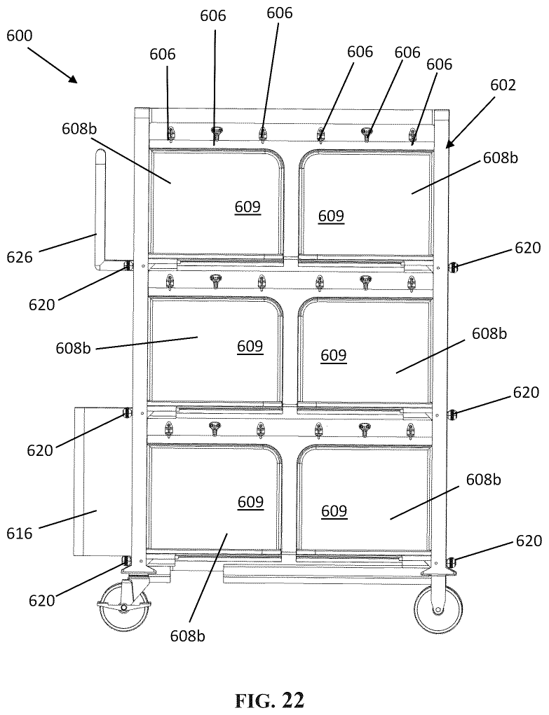

Notably, while the pick carts 130 are shown as generic shopping carts in FIG. 1 for simplicity, it will be appreciated that, preferably, any of the pick carts described with reference to the embodiments illustrated in FIGS. 3-26 may be advantageously used at the workstation 115 instead of the pick carts 130. It should also be noted that, while FIG. 1 shows two pick carts 130, namely, one pick cart 130 adjacent an A side picking location or station 116 of the workstation 115, and one pick cart 130 adjacent a B side picking location or station 118, optionally, a third pick cart 130 may be placed behind the operator 125 adjacent the bagging location or station 124. Further, it should be noted that the pick carts according to the exemplary embodiments described herein do not necessarily have to be used in conjunction with the automated product storage facility 100 or the product storage structure 102, but may be used at any product storage facility, where products are stored and/or transported from one location to another.

As noted above, in some embodiments, instead of a human operator 125 picking the products/goods from the totes 132 and placing the products/goods into the containers/bags 120 at the workstation 115, the workstation 115 may include a robot with one or more robotic arms for picking the products/goods from the totes 132 and placing the picked products/goods into the bags 120, such as disclosed, for example, in U.S. patent application Ser. No. 17/338,814, filed Jun. 4, 2021 and entitled “Robotic Each Picking in a Micro-Fulfillment Center,” which is hereby incorporated by reference in its entirety. As used herein, a product or products that may be ordered by consumers may be referred to as “a good” or “goods”, an individual product or good may be referred to as an “each”, and individual ones of the products or goods may be referred to as “eaches.”

In the workstation 115 according to the exemplary embodiment shown in FIG. 1, the bagging location or bagging station 124 is shown as having three side-by-side containers/bags 120 (although it will be appreciated that more or less bags 120 may be located at the bagging location 124 of the workstation 115). The container/bags 120 in the bagging location 124 may be made of cardboard, or of any other suitable material such as plastic, and may have sizes and shapes different from the exemplary containers/bags 120 shown in FIG. 1. For example, the bagging location 124 may store bags 120 that are bags (e.g., plastic bags, paper bags, cloth bags, single use bags, multi-use bags, tote liners, etc.) instead of, or in combination with the exemplary bags 120 illustrated in FIG. 1. Notably, while the exemplary bags 120 illustrated in FIG. 1 are not shown with handles, it will be appreciated that any of the bags 120 described herein may include handles that facilitate easier carrying of the bags 120 by the user.

In the exemplary embodiment shown in FIG. 1, mobile robots 135 are shown as having brought the totes 132 to the picking positions A and B 116 and 118, respectively of the workstation 115. The exemplary bagging location 124 of the workstation 115 is shown located between the tote presentation locations/picking locations A and B 116 and 118, respectively, of workstation 115. In some embodiments, the container/bags 120 may be automatically pre-loaded into the bagging location 124 at the picking positions A and B 116 and 118 via an optional container dispenser, for example, such as described in U.S. patent application Ser. No. 17/884,345, filed Aug. 9, 2022, and entitled “Container to Tote Dispense Integrated With Automated Storage and Retrieval System,” which is hereby incorporated by reference in its entirety.

In some implementations, the operator 125 of the workstation 115 may be free to arbitrarily pick eaches from the product tote(s) 132 and/or to keep adding eaches to the container(s)/bag(s) 120 at the bagging station 124 in conjunction with order fulfillment until the operator 125 deems the container(s)/bag(s) 120 to be full. The operator 125 may then remove the container(s)/bag(s) 120 from the bagging station 124 and transfer such container(s)/bag(s) 120 onto a pick cart 130, multiple exemplary embodiments of which will be described in more detail below. For example, in some embodiments, eaches (i.e., individual products) are sequentially picked by the operator 125 from product tote(s) 132 on either or both picking areas A and B 116, 118, after which the picked eaches are placed by the operator 125 into one or more bags 120 that are located at the bagging location 124 of the workstation 115.

Then, the operator 125 may move the bags 120 filled according to the pending orders being fulfilled directly onto one or more pick carts 130 located at the workstation 115, after which the pick carts 130 containing the bags 120 may be moved by the operator 125 or another worker (or guided via a remote control) to a storage area (e.g., an order pickup area, which may include temperature-controlled sections (e.g., ambient, refrigerated, frozen)), where a customer may pick up one or more bags 120 containing the products ordered by the customer from the retailer, or where a worker may remove the bags 120 from the pick cart 130 (or pick one or more customer-ordered products from the bag(s) 120 on the pick cart 130) and hand the bag 120 containing the customer-ordered product(s) (or the customer-ordered product(s) without the bag 120 to the customer).

In some embodiments, after the operator 125 picks the eaches from the product totes 132 on either or both location A 116 and/or location B 118 of the workstation 115, instead of placing the picked eaches into the bags 120 located at the bagging location 124 of the workstation 115, the operator 125 may place the picked eaches into bags 120 that are preloaded onto one or more pick carts 130 located at the workstation 115. Notably, in some embodiments, the bags 120 located on the pick carts 130 may be automatically pre-loaded into the pick carts 130 via a bag dispenser, such as disclosed in U.S. patent application Ser. No. 17/884,345, filed Aug. 9, 2022, and entitled “Container to Tote Dispense Integrated With Automated Storage and Retrieval System,” incorporated by reference herein in its entirety. Then, the pick carts 130 with bags 120 containing the products associated with the customer orders being picked up by the customers may be moved by the operator 125 or another worker (or guided via a remote control) to an order pickup area, where a worker or a customer may remove the bags 120 from the pick cart 130.

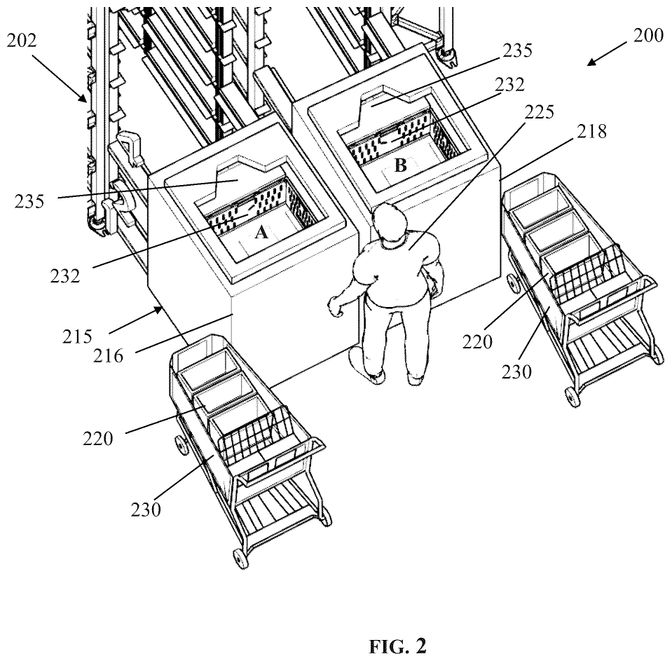

FIG. 2 shows a perspective view of another embodiment of workstation 215 of an automated order fulfillment facility 200 including a product storage structure 202 and mobile robots 235. Similar to the workstation 115 of FIG. 1, the exemplary workstation 215 permits an operator 225 to access an A side picking location or station 216 or a B side picking location or station 218. Notably, while the pick carts 130 are shown as generic carts in FIG. 2 for simplicity, it will be appreciated that, preferably, any of the pick carts described with reference to the embodiments illustrated in FIGS. 3-36 may be advantageously used at the workstation 215 instead of the generic pick carts 130 illustrated in FIG. 2.

Notably, unlike the workstation 115 shown in FIG. 1, the workstation 215 shown in FIG. 2 does not include a bagging location or station akin to the bagging location or station 124 between the A side picking location 216 and the B side picking location 218. Instead, as will be described in more details below, the containers/bags 220 into which the eaches picked from the picking station A 216 and/or picking station B 218 are placed by the operator 225 are located in (and are preferably automatically pre-filled onto) one or more pick carts 230 that are located at the workstation 215.

Like FIG. 1, FIG. 2 shows mobile robots 235 positioned after the mobile robots 235 bring the totes 232 to the respective picking positions A and B 216 and 218 of the workstation 215. Unlike FIG. 1, however, the bags 220 into which the products are placed after being picked from the totes 232 are not located at a bagging location or station 124 (which is absent from the embodiment of the workstation 115 shown in FIG. 2), but are instead located directly on the pick carts 230. As mentioned above, in some embodiments, the bags 220 may be automatically pre-loaded into the pick carts 230 via an optional container dispenser into their respective locations on the pick carts 230, as disclosed, for example, in U.S. patent application Ser. No. 17/884,345, filed Aug. 9, 2022, and entitled “Container to Tote Dispense Integrated With Automated Storage and Retrieval System,” which is hereby incorporated by reference in its entirety.

In some implementations, the operator 225 of the workstation 215 may be free to arbitrarily pick eaches from the product tote(s) 232 and/or to keep adding eaches to the bags 220 located on the pick cart(s) 230 until the operator 225 deems the bag(s) 220 to be full. In one aspect, the workstation 215 may include an electronic display that displays specific instructions to the operator 225 with respect to which products to remove from which product tote(s) 232 in which sequence, and which bags 220 or pick carts (230) the products removed from the product tote(s) 232 should be placed into by the operator 225. In one exemplary embodiment of operation of the workstation 215, eaches (i.e., individual products) are sequentially picked by the operator 225 from the product tote(s) 232 on either or both picking areas A and B 216 and 218, after which the picked eaches are placed by the operator 225 into one or more bags 220 that are located on one or more pick carts 230 located at the workstation 215. Then, the pick carts 230 containing the bags 220 may be moved by the operator 225 or another worker of the product storage facility (or guided via a remote control) to an order pickup area (inside or outside of the product storage facility), where a worker may remove one or more bags 220 from the pick cart(s) 230 and hand over the customer-ordered product(s) to the customer(s).

In some embodiments, when it is known that the customer is not ready to pick up the customer-ordered items yet, the operator 225 may move the bags 220 filled according to the pending orders being fulfilled directly onto one or more pick carts 230 located at the workstation 215, and then move the pick cart(s) 230 containing the bag(s) 220 to a storage area (e.g., an order pickup area, which may include sections at ambient, refrigerated, and/or below-freezing temperature), where a customer may pick up one or more bags 220 containing the items ordered by the customer from the retailer, or where a worker of the product storage facility may remove one or more bags 220 from the pick cart 230, or remove one or more customer-ordered items from the bag(s) 120 on the pick cart 230, and hand over the bag 220 containing the customer-ordered item(s) (or the customer-ordered item(s) without the bag 220 to the customer.

In some embodiments, after the operator 225 picks the eaches from the product totes 232 on either or both location A 216 and/or location B 218 of the workstation 215, instead of placing the picked eaches into the bags 220 located at the bagging location 224 of the workstation 215, the operator 225 may place the picked eaches into bags 220 that are preloaded onto one or more pick carts 230 located at the workstation 215. Notably, in some embodiments, the bags 220 located on the pick carts 230 may be automatically pre-loaded onto the pick carts 230 via a bag dispenser, such as disclosed, for example, in U.S. patent application Ser. No. 17/884,345, filed Aug. 9, 2022, and entitled “Container to Tote Dispense Integrated With Automated Storage and Retrieval System,” incorporated by reference herein in its entirety. Then, the pick carts 230 with bags 220 containing the products associated with the customer orders being picked up by the customers may be moved by the operator 225 or another worker (or guided via a remote control) to an order pickup area of the product storage facility, where a worker or a customer may pick up the products ordered by the customer from the retailer by removing the product-containing bags 220 from the pick cart 230 (or from a storage area designated for bags 220 to be picked up by customers).

FIGS. 3-9 show an exemplary pick cart 300 for transporting bags at a product storage facility. The pick cart 300 includes a frame 302 and wheels 304a-304d mounted to and supporting the frame 302. In the illustrated embodiment, the pick cart 300 includes first support members 306 extending from the frame 302, as well second support members 308 mounted relative to the frame 302. As can be seen in FIG. 3, the first support members 306 are different from the second support members 308, with each of the exemplary first support members 306 comprising a hook, and each of the second support members 308 comprising a tray or a shelf. Generally, the first support members 306 may be sized and shaped to support handles of various product storage bags thereon, while the second support members 308 may be sized and shaped to support bottoms of various product storage bags thereon.

In the embodiment shown in FIG. 3, the first support members 306 are fixedly mounted (i.e., are not intended to be moved) relative to the frame 302, but it will be appreciated that, in some embodiments, the first support members 306 may be movably mounted relative to the frame 302. On the other hand, in the embodiment shown in FIG. 3, the second support members 308 are movably mounted (i.e., such that their movement is permitted) relative to the frame 302, but it will be appreciated that, in some embodiments, the second support members 308 may be fixedly mounted relative to the frame 302.

In the embodiment illustrated in FIG. 3, the exemplary pick cart 300 further includes a vertical divider member 310, which may be made of, for example, plastic, cardboard, metal, or the like. In the exemplary pick cart 300 shown in FIG. 3, second support members 308 extend away from the vertical divider member 310 on both sides, with some of the second support members 308 extending away from one side 312 of the vertical divider member 310 and some of the second support members 308 extending away from an opposite side 314 of the vertical divider member 310. FIG. 3 also shows that the exemplary pick cart 300 includes a bag dispenser 316 coupled to the frame 302 and configured to store a plurality of bags when the bags are not in use.

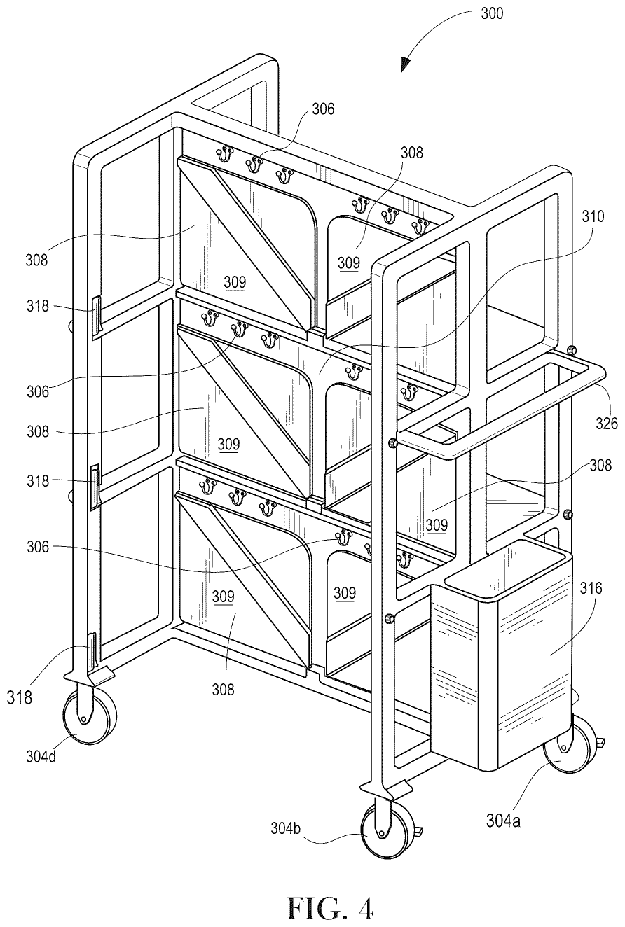

In the embodiment illustrated in FIG. 3, the exemplary pick cart 300 includes three rows of first support members 306 and three rows of second support members 308 extending on a first side 312 of the vertical divider member 310. In addition, as can be seen, for example, in FIG. 4, the exemplary pick cart 300 further includes at least three rows of first support members 306 and three rows of second support members 308 extending on a second, opposite, side 314 of the vertical divider member 310. In the exemplary pick cart 300 illustrated in FIG. 3, each row of the first support members 306 includes six first support members 306, and each row of the second support members 308 includes two second support members 308, with three first support members 306 being positioned above each one of the second support members 308. FIG. 3 also shows that, in the pick cart 300, the first (i.e., top) row of the second support members 308 is located between the first (i.e., top) row and the second (i.e., middle) row of the first support members 306, the second row of the second support members 308 is located between the second (i.e., middle) row and the third (i.e., bottom) row of the first support members 306, and the third (bottom) row of the second support members 308 is located below the third row of the first support members 306.

It will be appreciated, that in some embodiments, the pick cart 300 may include less than three (e.g., one or two) or more than three rows (four, five, six, etc.) rows of first and second support members 306 and 308, and that each of the second support members 308 may have less than three (e.g., one or two) first support members 306, or more than three (four, six, etc.) first support members 306 above it. For example, depending on the size of the pick cart 300, and on the number and size of the first support members 306 and second support members 308, in some embodiments, the pick cart 300 may support from 1 to 48 (or more) product storage bags, for example, 6 product storage bags, 12 product storage bags, 24 product storage bags, 36 product storage bags, 48 product storage bags, 60 product storage bags, 72 product storage bags, etc.

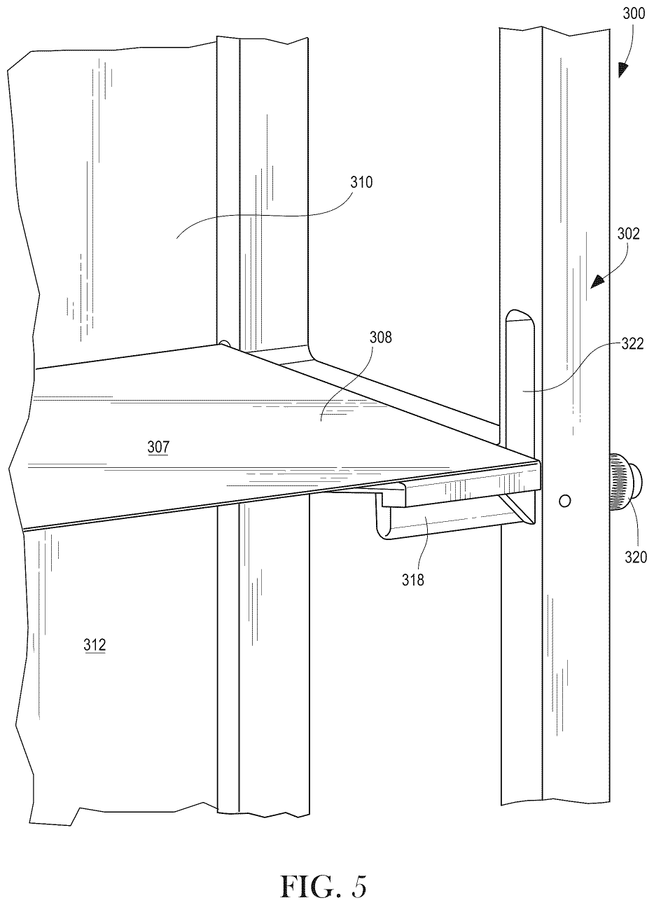

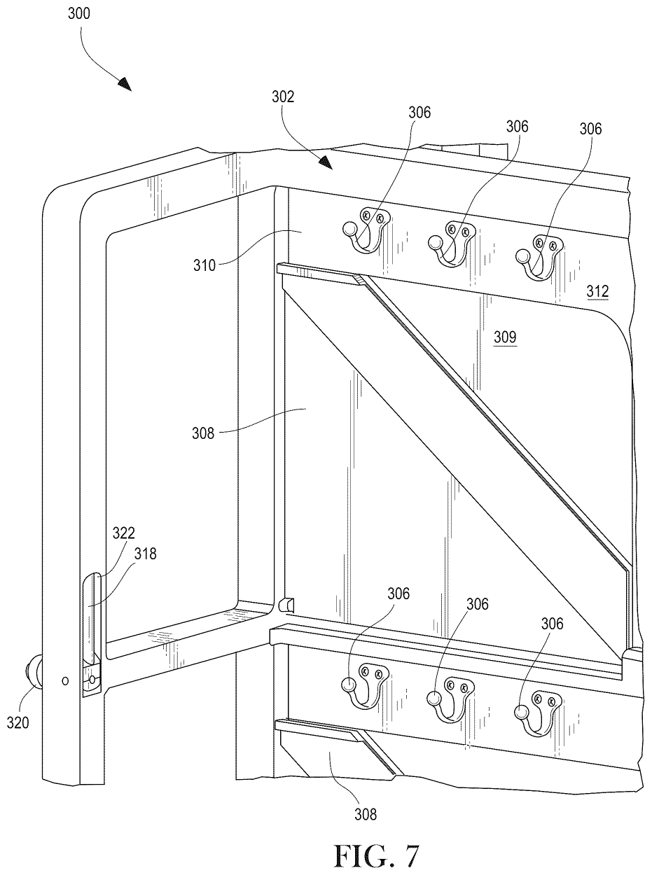

As will be discussed in more detail below, the second support members 308 are movably (e.g., pivotally) coupled relative to the frame 302 and the vertical divider member 310, such that each of the second support members 308 is permitted to independently pivot upwardly and downwardly relative to the frame 302 and the vertical divider member 310. For example, in some aspects, each of the second support members 308 is permitted to fold up relative to the frame 302 and the vertical divider member 310 from a horizontal position shown in FIG. 3 to a vertical position shown in FIGS. 4 and 7, and to fold back down relative to the frame 302 and the vertical divider member 310 from the vertical position shown in FIG. 4 back to the horizontal position shown in FIGS. 3 and 5.

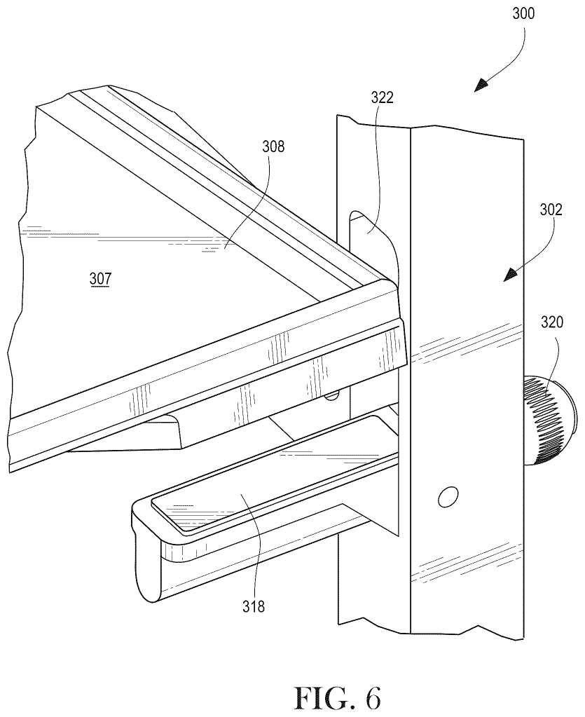

The exemplary pick cart 300 shown in FIGS. 3-4 includes latches 318 that are movably mounted relative to the frame 302. In some embodiments, each of the latches 318 is movable from a horizontal position as shown in FIG. 3 to a vertical position as shown in FIG. 4. When in the horizontal position, each of the latches 318 supports a respective one of the second support members 308 when the second support members 308 are in their initial horizontal position, as shown in FIG. 3. Notably, FIG. 6 shows an exemplary second support member 308 as being spatially separated from its supporting latch 318 at a point of the movement of the second support member 308 from its horizontal position of FIG. 3 to the vertical position of FIG. 4. On the other hand, when the second support members 308 are in their vertical position, the latches 318 may be moved to their respective vertical positions as shown in FIG. 4. In certain aspects, each of the latches 318 is operably coupled to a handle or a knob 320, the movement of which (e.g., by the hand of the operator of the pick cart 300) causes a responsive movement of its respective latch 318. For example, in one implementation, clockwise movement of a knob 320 causes the latch 318 to pivot from its horizontal position shown in FIG. 3 to its vertical position shown in FIG. 4.

In some embodiments, when each of the second support members 308 is in its horizontal position as shown in FIG. 3, each of the second support members 308 may support one, two, or three (or, in some, embodiments, more) product storage bags, which may or may not have handles. In one aspect, each of the second support members 308 may support three bags with handles, such that the bottom of each of the bags is supported on the upwardly-facing surface 307 of a respective one of the second support members 308, and such that the handle or handles of each of the bags is supported by (e.g., by hanging on) one or two of the respective first support members 306. In some aspects, the ability of each of the second support members 308 to pivot/fold upwardly relative to the frame 302 advantageously facilitates both easy placement of bags onto, and easy removal of bags from, the second support members 308 located below second support members 308 that have been folded up.

Notably, the ability of each of the second support members 308 to pivot/fold upwardly relative to the frame 302 also advantageously enables the pick cart to store both conventional and unconventionally large bags. For example, in one aspect, the top left second support member 308 may be folded up such that a larger-than-normal bag may be placed on the middle left second support member 308 and, if this larger-than-normal bag includes handles, the handles of this bag may be hanged not on one or two of the first support members 306 mounted on an underside 309 of the top left second support member 308, but on one or two of the first support members mounted to the frame 302 above the top left second support member 308. In another aspect, both the top left and the middle left second support members 308 may be folded up such that a larger-than-normal bag may be placed on the bottom left second support member 308. If this larger-than-normal bag includes handles, the handles of this bag may be hanged not on one or two of the first support members 306 mounted on an underside 309 of the middle or top left second support members 308, but on one or two of the first support members mounted to the frame 302 above the top left second support member 308.

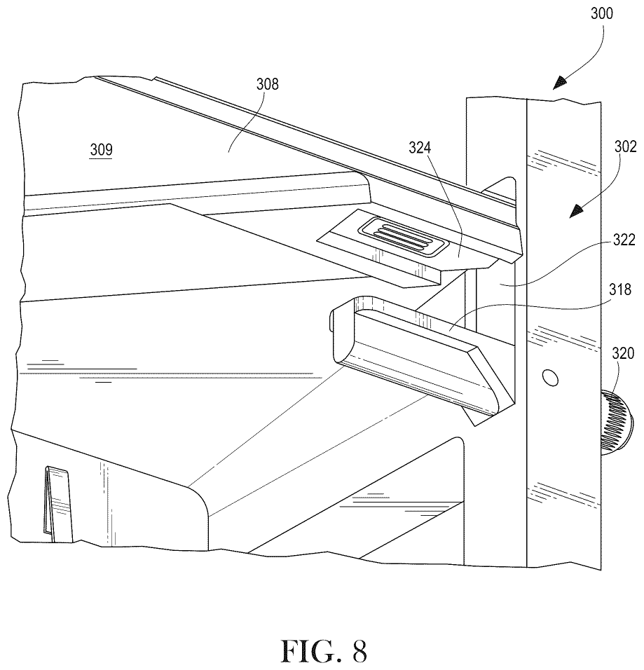

In some embodiments (see FIG. 4 and FIG. 5), the frame 302 of the pick cart 300 may include recesses, grooves 322 or the like located adjacent each one of the latches 318, and sized and shaped to receive at least a part of the latches 318 when the latches 318 are in their vertical positions. In one aspect, each groove 322 is sized and shaped to fully receive its respective latch 318, such that the entirety of the latch 318 is received within and does not protrude outwardly from its respective groove 322 (see, e.g., FIG. 7). In one embodiment, a downwardly-facing surface 309 of each of the second support members 308, which is opposite of the upwardly-facing surface 307 of each of the second support members 308 on which the product-containing bags or the like may be stored, may include one or more recesses, grooves 324 or the like located adjacent each one of the latches 318, and sized and shaped to receive at least a part of the latches 318 when the latches 318 are in their horizontal positions (see FIG. 8). In one aspect, each groove 324 is sized and shaped to fully receive its respective latch 318, such that the entirety of the latch 318 may be received within and would not protrude outwardly from its respective groove 324 (see FIG. 8).

In the embodiment illustrated in FIG. 3, the pick cart 300 includes a handlebar 326 mounted to the frame 302 that permits an operator of the pick cart 300 to grasp the handlebar 326 and to push/pull the pick cart 300 via the handlebar 326. In some aspects, the handlebar 326 may be fixedly mounted to the frame 302 of the pick cart 300. In other aspects, the handlebar 326 may be movably/pivotally mounted relative to the frame 302, such that the handlebar 326 may be folded (e.g., by pivoting up or down) when the pick cart 300 is not in use.

In some embodiments, the pick cart 300 has four wheels 304a-304d. In one aspect, to improve the maneuverability of the pick cart 300, the two rear wheels 304a and 304b are swivel casters that permit the operator of the cart to complete a full 360-degree rotation of the rear wheels 304a-304b. On the other hand, the two front wheels 304c and 304d may be directional lock casters, which include a locking mechanism (e.g., a stopper, a latch, or the like) that enables the operator of the pick cart 300 to lock the front wheels 304c-304d in any desired position (e.g., straight along the axis of movement of the pick cart 300), preventing the front wheels 304c and 304d from swiveling while locked.

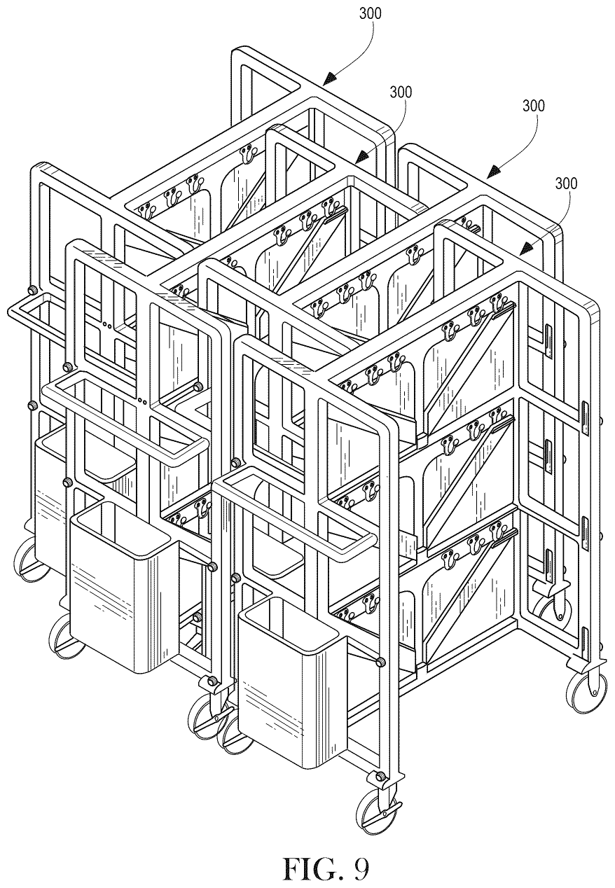

As shown in FIGS. 3 and 4, the frame 302 of the exemplary pick cart 300 is shaped in i-beam form, which enables multiple pick carts 300, after the second support members 308 are folded up, to be nested within each other for storage when not in use, thereby advantageously providing a significant savings of the storage space required to store the pick carts 300 while they are not being used. One example of four pick carts 300 positioned in a nested configuration for storage when not in use is illustrated in FIG. 9. As can be clearly seen with reference to FIG. 9, if the four pick carts 300 were simply positioned next to each other instead of being partially nested within one another as shown in FIG. 9, the storage space that would be required to accommodate these four pick carts 300 would be significantly larger, which would make a big difference for a large-scale product storage facility, where hundreds or thousands of pick carts 300 may be stored.

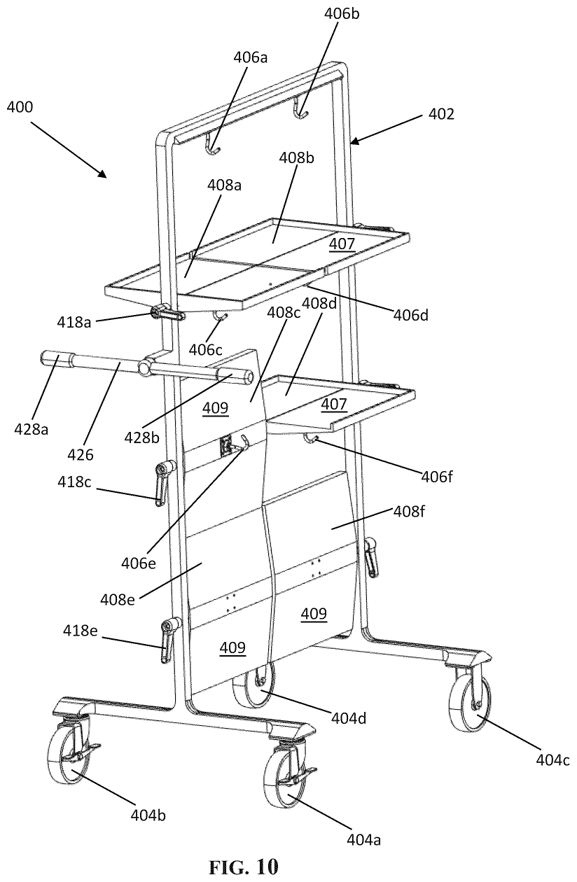

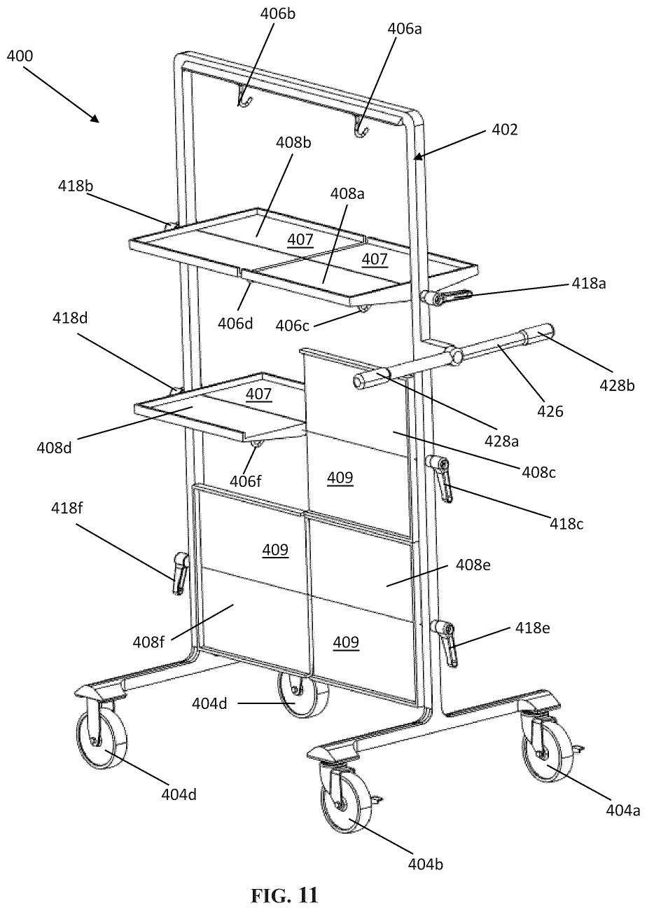

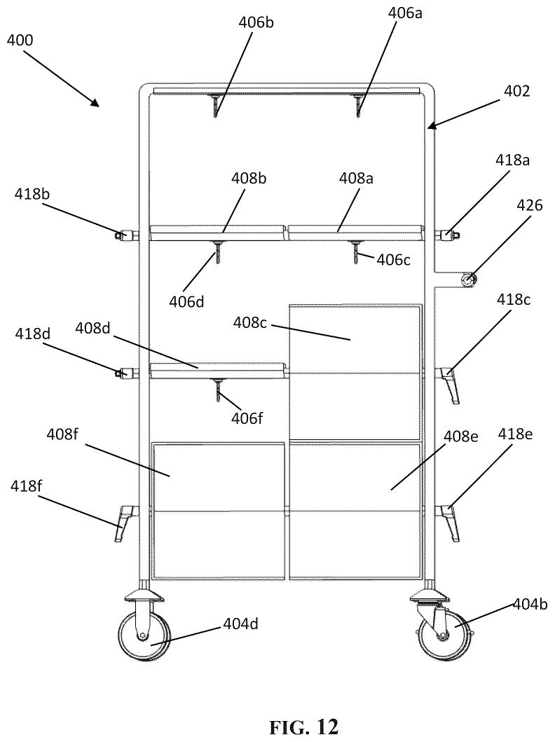

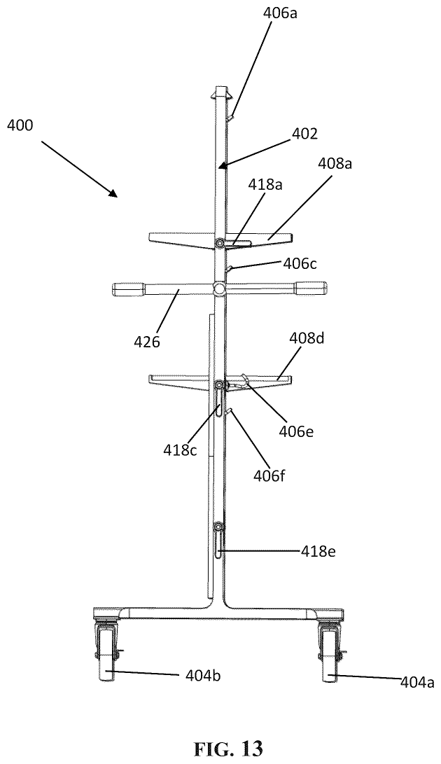

FIGS. 10-13 show an exemplary pick cart 400 for transporting bags at a product storage facility. The pick cart 400 includes a frame 402 and wheels 404a-404d mounted to and supporting the frame 402. In the illustrated embodiment, the pick cart 400 includes first support members 406a-406f extending from the frame 402, as well second support members 408a-408f mounted relative to the frame 402. As can be seen in FIG. 10, the first support members 406a-406f are different from the second support members 408a-408f, with each of the exemplary first support members 406a-406f comprising a hook, and each of the second support members 408a-408f comprising a tray or a shelf. Generally, the first support members 406a-406f shown in FIG. 10, FIG. 11, FIG. 12, and FIG. 13 are sized and shaped to support handles of various product storage bags thereon, while the second support members 408a-408f are sized and shaped to support bottoms of various product storage bags thereon.

In the embodiment shown in FIG. 10, some of the first support members 406a-406b are fixedly mounted (i.e., are not intended to be moved) relative to the frame 402, and some of the support members 406c-406f are fixedly mounted (i.e., are not intended to be moved) relative to their respective support members (e.g., 408a-408d). Notably, in the embodiment shown in FIG. 10, each of the second support members 408a-408f is movably mounted (i.e., such that their movement is permitted) relative to the frame 402. It will be appreciated, however, that, in some embodiments, the second support members 408a-408f may be fixedly mounted relative to the frame 402. Notably, by virtue of the fact that the second support members 408a-408d are movably mounted relative to the frame 402, the first support members 406c-406f are movably mounted relative to the frame 402 while being fixedly mounted to their respective second support members 408a-408d. In the embodiment shown in FIG. 10, FIG. 11, FIG. 12, and FIG. 13, unlike the two top second support members 408a and 408b and two middle support members 408c and 408d, each of which has a respective first support member 406c-406f mounted to an underside 409 thereof, the two bottom second support members 408e and 408f do not have first support members mounted on their respective undersides 409. Notably, each of the second support members 408a-408f includes an upwardly-facing surface 407 on which the product-containing bags or the like may be stored.

Notably, unlike the exemplary pick cart 300 of FIG. 3, the exemplary pick cart 400 of FIG. 10 does not include a vertical divider member akin to the vertical divider member 310 of the pick cart 300, or a bag dispenser akin to the bag dispenser 316 of the pick cart 300. It will be appreciated, however, that, in some embodiments, the pick cart 400 may include a bag dispenser coupled to the frame 402 and configured to store a plurality of product storage bags when the bags are not in use.

In the embodiment illustrated in FIG. 10, the exemplary pick cart 400 includes three rows of first support members 406a-406f and three rows of second support members 408a-408f. In the exemplary pick cart 400 illustrated in FIG. 10, each row of the first support members includes two first support members, and each row of the second support members includes two second support members, with one first support member 406a-406f being positioned above a respective one of the second support members 408a-408f. It will be appreciated, that in some embodiments, the pick cart 400 may include less than three (e.g., one or two) or more than three rows (four, five, six, etc.) rows of first and second support members 406a-406f and 408a-408f, and that each of the second support members 408a-408f may have more than one (e.g., two, three, four, etc.) first support members 406a-406f above it.

In the illustrated embodiment, the second support members 408a-408f are movably (e.g., pivotally) coupled relative to the frame 402, such that each of the second support members 408a-408f is permitted to independently pivot upwardly and downwardly relative to the frame 402. For example, in some aspects, each of the second support members 408a-408f is permitted to pivot relative to the frame 402 from a horizontal position (e.g., second support members 408a, 408b, and 408d) to a vertical position (e.g., second support members 408c, 408e, and 408f), and to fold back down relative to the frame 402 from the vertical position back to the horizontal position.

The exemplary pick cart 400 shown in FIGS. 10-13 includes latches 418a-418f that are movably mounted relative to the frame 402. As can be seen in FIG. 10, each of the latches 418a-418f is movable from a horizontal position (e.g., latches 418a, 418b, and 418d) to a vertical position (e.g., latches 418c, 418e, and 418f). When in the horizontal position, each of the latches 418a-418f supports a respective one of the second support members 408a-408f when the second support members 408a-408f are in their initial horizontal position. On the other hand, when the second support members 408a-408f are in their vertical position, the latches 418a-418f may be moved to their respective vertical positions. In certain aspects, each of the latches 418a-418f is coupled to its respective second support member 4z8a-408f such that the movement of each of the latches 418a-418f (e.g., by the hand of the operator of the pick cart 400) causes a responsive movement of its respective second support member 408a-4z8f. For example, if the latch 418a were to be rotated from its horizontal position as shown in FIG. 10 to its vertical position, this would cause the second support member 408a to move from its horizontal to its vertical position.

In the embodiment illustrated in FIG. 10, the pick cart 400 includes a handlebar 426 mounted to the frame 402 that permits an operator of the pick cart 400 to grasp the handlebar 426 (which may include rubber, plastic, or the like grips 428a and 428b to accommodate the hands of the operator) and to push/pull the pick cart 400 via the handlebar 426. In some aspects, the handlebar 426 may be fixedly mounted to the frame 402 of the pick cart 400. In other aspects, the handlebar 426 may be movably/pivotally mounted relative to the frame 402, such that the handlebar 426 may be pivoted from a horizontal position as shown in FIG. 10 to a vertical position (which would facilitate the nesting of several pick carts 400) when the pick cart 400 is not in use.

In some embodiments, the pick cart 400 has four wheels 404a-404d. In one aspect, to improve the maneuverability of the pick cart 400, the two rear wheels 404a and 404b are swivel casters that permit the operator of the cart to complete a full 360-degree rotation of the rear wheels 404a-404b. On the other hand, the two front wheels 404c and 404d are directional lock casters, which include a locking mechanism (e.g., a stopper, a latch, or the like) that enables the operator of the pick cart 400 to lock the front wheels 404c-404d in any desired position (e.g., straight along the axis of movement of the pick cart 400), preventing the front wheels 404c and 404d from swiveling while locked.

As shown in FIGS. 10-13, the frame 402 of the exemplary pick cart 400 is shaped in i-beam form, which enables multiple pick carts 400, after the second support members 408a-408f are folded up (and, optionally, after their handle bar 426 is oriented into its vertical position), to be nested within each other for storage when not in use, thereby advantageously providing a significant savings of the storage space at the product storage facility required to store the pick carts 400 while they are not being used.

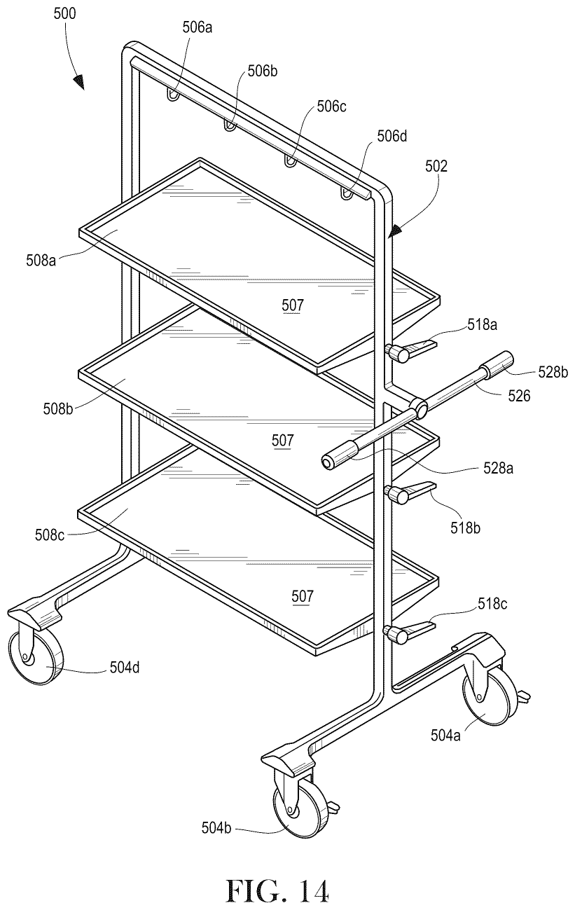

FIGS. 14-19 show an exemplary pick cart 500 for transporting bags at a product storage facility. The pick cart 500 includes a frame 502 and wheels 504a-504d mounted to and supporting the frame 502. In the illustrated embodiment, the pick cart 500 includes first support members 506a-506m extending from the frame 502, as well second support members 508a-508c mounted relative to the frame 502. As can be seen in FIG. 10, the first support members 506a-506m are different from the second support members 508a-508c, with each of the exemplary first support members 506a-506m comprising a hook, and each of the second support members 508a-508c comprising a tray or a shelf. Generally, the first support members 506a-506m are sized and shaped to support handles of various product storage bags thereon, while the second support members 508a-508c are sized/shaped to support bottoms of various product storage bags thereon.

In the embodiment shown in FIG. 14, some of the first support members 506a-506d are fixedly mounted (i.e., are not intended to be moved) relative to the frame 502, and some of the support members 506e-506m are fixedly mounted (i.e., are not intended to be moved) relative to their respective support members (e.g., 508a-508c). Notably, in the embodiment shown in FIG. 14, each of the second support members 408a-408c is movably mounted (i.e., such that their movement is permitted) relative to the frame 502. It will be appreciated, however, that, in some embodiments, the second support members 508a-508c may be fixedly mounted relative to the frame 502. Notably, by virtue of the fact that the second support members 508a-508c are movably mounted relative to the frame 502, the first support members 506e-506m are movably mounted relative to the frame 502 while being fixedly mounted to their respective second support members 508a-408c. In the illustrated embodiment, unlike the top second support member 508a and the middle support member 508b, each of which has respective first support members 506e-506h and 506i-506m mounted to an underside 509 thereof, the bottom second support member 508c does not have first support members mounted on its underside 509. Notably, each of the second support members 508a-508c includes an upwardly-facing surface 507 on which the product-containing bags or the like may be stored.

Notably, unlike the exemplary pick cart 300 of FIG. 3, the exemplary pick cart 500 of FIG. 14 does not include a vertical divider member akin to the vertical divider member 310 of the pick cart 300, or a bag dispenser akin to the bag dispenser 316 of the pick cart 300. It will be appreciated, however, that, in some embodiments, the pick cart 500 may include a bag dispenser coupled to the frame 502 and configured to store a plurality of product storage bags when the bags are not in use.

In the embodiment illustrated in FIG. 14, the exemplary pick cart 500 includes three rows of first support members 506a-406m and three rows of second support members 508a-508f. In the exemplary pick cart 500 illustrated in FIG. 14, each row of the first support members includes four first support members, and each row of the second support members includes one second support member, with four respective first support members 506a-506m being positioned above a respective one of the second support members 508a-508c. It will be appreciated, that in some embodiments, the pick cart 500 may include less than three (e.g., one or two) or more than three rows (four, five, six, etc.) rows of first and second support members 506a-506m and 508a-508c, and that each of the second support members 508a-508c may have more than four (e.g., five, six, etc.) or less than four (e.g., three two, one etc.) first support members 506a-506m above it.

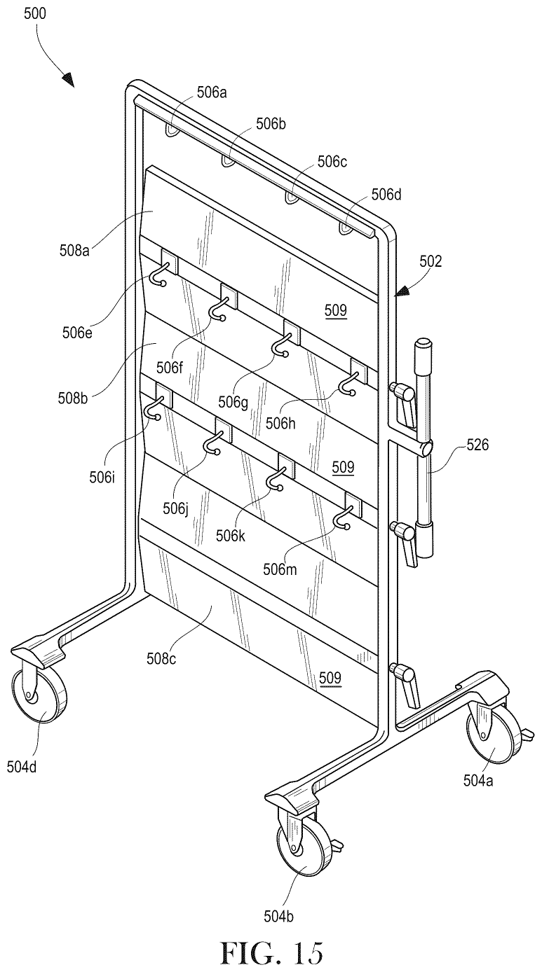

In the illustrated embodiment, the second support members 508a-508c are movably (e.g., pivotally) coupled relative to the frame 502, such that each of the second support members 508a-508c is permitted to independently pivot upwardly and downwardly relative to the frame 502. For example, in some aspects, each of the second support members 508a-508c is permitted to pivot relative to the frame 502 from a horizontal position shown in FIG. 14 to a vertical position shown in FIG. 15, and to fold back down relative to the frame 502 from the vertical position back to the horizontal position.

The exemplary pick cart 500 shown in FIGS. 14-19 includes latches 518a-518c that are movably mounted relative to the frame 502. As can be seen in FIG. 14, each of the latches 518a-518c is movable from a horizontal position as seen in FIG. 14 to a vertical position as seen in FIG. 15. When in the horizontal position, each of the latches 518a-518c supports a respective one of the second support members 508a-508c when the second support members 508a-508c are in their initial horizontal position. On the other hand, when the second support members 508a-408c are in their vertical position, the latches 518a-518c may be moved to their respective vertical positions. In certain aspects, each of the latches 518a-518c is coupled to its respective second support member 558a-508c such that the movement of each of the latches 518a-518c (e.g., by the hand of the operator of the pick cart 500) causes a responsive movement of its respective second support member 518a-518f. For example, if any one of the latches 518a-518c are rotated from its horizontal position as shown in FIG. 14 to its vertical position as shown in FIG. 15, the respective one of the second support members 508a-508c would be caused to move from its horizontal to its vertical position as shown in FIG. 15.

In the embodiment illustrated in FIG. 14, the pick cart 500 includes a handlebar 526 mounted to the frame 502 that permits an operator of the pick cart 500 to grasp the handlebar 526 (which may include rubber, plastic, or the like grips 528a and 528b to accommodate the hands of the operator) and to push/pull the pick cart 500 via the handlebar 526. In some aspects, the handlebar 526 may be fixedly mounted to the frame 502 of the pick cart 500. In other aspects, the handlebar 526 may be movably/pivotally mounted relative to the frame 502, such that the handlebar 526 may be pivoted from a horizontal position as shown in FIG. 14 to a vertical position as shown in FIG. 15 (which would facilitate the nesting of several pick carts 400) when the pick cart 500 is not in use.

In some embodiments, the pick cart 500 has four wheels 504a-504d. In one aspect, to improve the maneuverability of the pick cart 500, the two rear wheels 504a and 504b are swivel casters that permit the operator of the cart to complete a full 360-degree rotation of the rear wheels 504a-504b. On the other hand, the two front wheels 504c and 504d are directional lock casters, which include a locking mechanism (e.g., a stopper, a latch, or the like) that enables the operator of the pick cart 500 to lock the front wheels 504c-504d in any desired position (e.g., straight along the axis of movement of the pick cart 500), preventing the front wheels 504c and 504d from swiveling while locked.

As shown in FIGS. 14-15, the frame 502 of the exemplary pick cart 500 is shaped in i-beam form, which enables multiple pick carts 500, after the second support members 508a-508c are folded up (and, optionally, after their handle bar 526 is oriented into its vertical position), to be nested within each other for storage when not in use, thereby advantageously providing a significant savings of the storage space at the product storage facility required to store the pick carts 500 while they are not being used.

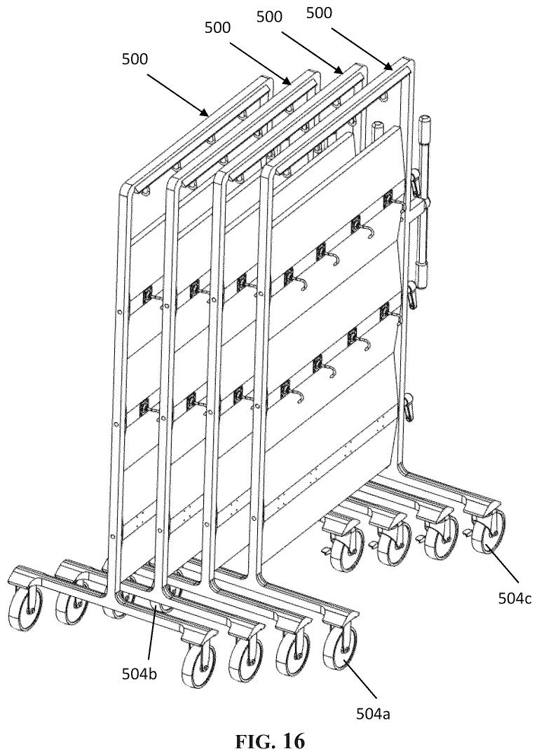

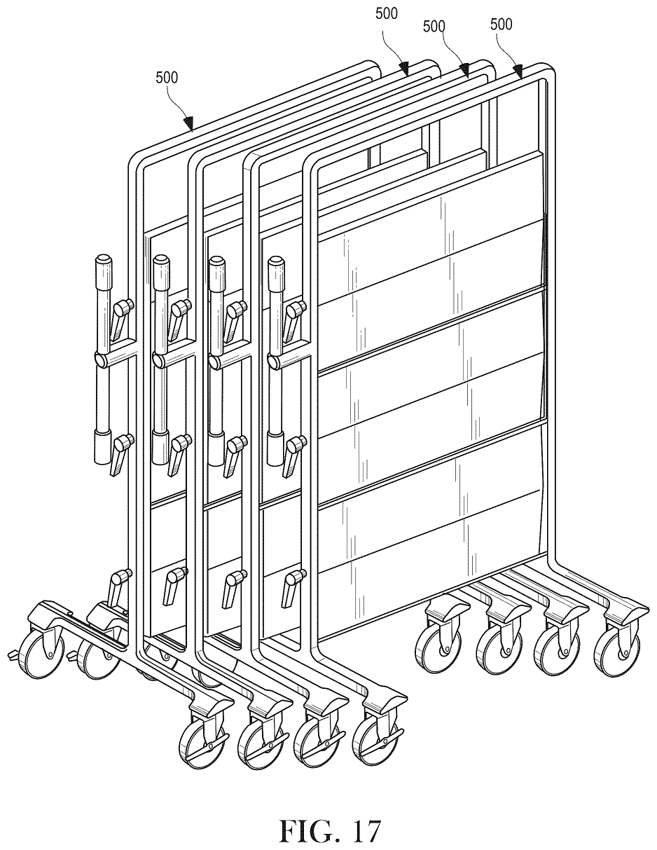

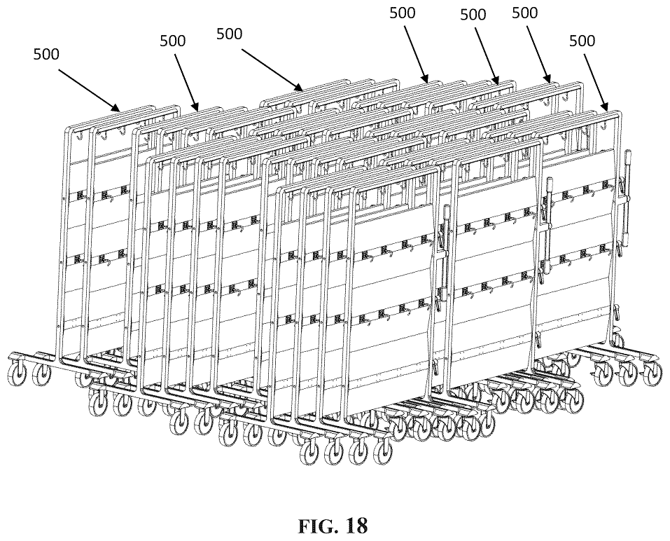

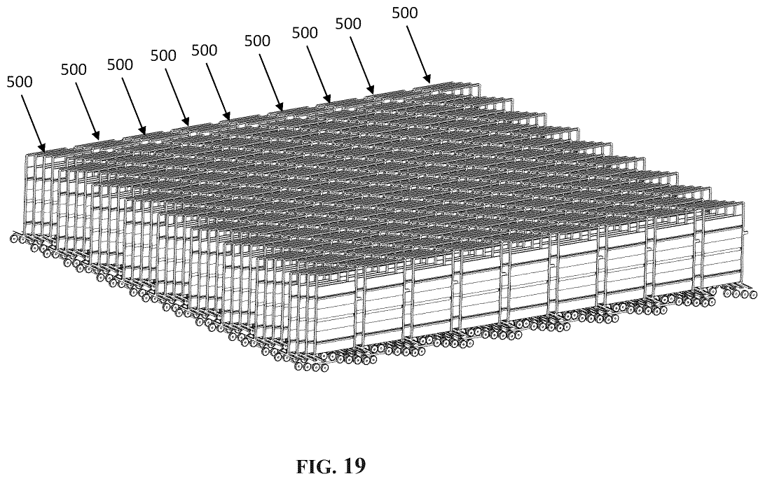

Two examples of four pick carts 500 positioned in a nested configuration for storage when not in use are illustrated in FIG. 16 and FIG. 17. An example of forty-two pick carts 500 positioned in a nested configuration for storage when not in use is illustrated in FIG. 18, and an example of several hundred carts 500 positioned in a nested configuration for storage when not in use is illustrated in FIG. 19. As can be clearly seen with reference to FIG. 16, FIG. 17, FIG. 18, and FIG. 19, if the pick carts 500 were simply positioned next to each other instead of being partially nested within one another as shown in FIGS. 16-19, the storage space that would be required to accommodate these pick carts 500 would be significantly larger, which would make a big difference for any large-scale product storage facility.

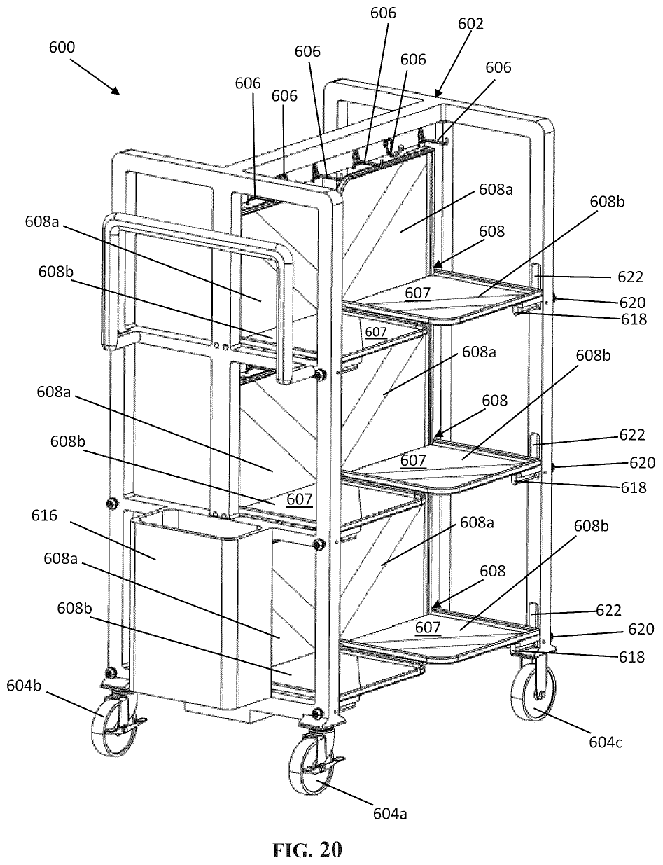

FIGS. 20-26 show an exemplary pick cart 600 for transporting bags at a product storage facility. The pick cart 600 includes a frame 602 and wheels 604a-604d mounted to and supporting the frame 602. In the illustrated embodiment, the pick cart 600 includes first support members 606 extending from the frame 602, as well second support members 608 mounted relative to the frame 602. As can be seen in FIG. 20, the first support members 606 are different from the second support members 608, with each of the exemplary first support members 606 comprising a hook, and each of the second support members 608 comprising a tray or a shelf.

Unlike the embodiment of the pick cart 300 shown in FIG. 3, where all of the first support members 306 are identical in shape, the pick cart 600 according to the embodiment shown in FIG. 20 includes different types of first support members 606, with some of the first support members 606 being in the form of hooks akin to the hooks of the pick cart 300, and some of the first support members 606 being in the form of hanging rods having turned-up distal ends that resemble hooks. Generally, the first support members 606 may be sized and shaped to support handles of various product storage bags thereon, while the second support members 608 may be sized and shaped to support bottoms of various product storage bags thereon.

In the embodiment shown in FIG. 20, the first support members 606 are fixedly mounted (i.e., are not intended to be moved) relative to the frame 602, but it will be appreciated that, in some embodiments, the first support members 606 may be movably mounted relative to the frame 602. On the other hand, in the embodiment shown in FIG. 20, the second support members 608 are movably mounted (i.e., such that their movement is permitted) relative to the frame 602, but it will be appreciated that, in some embodiments, the second support members 608 may be fixedly mounted relative to the frame 602.

Notably, unlike the exemplary pick cart 300 of FIG. 3, the exemplary pick cart 600 of FIG. 20 does not include a vertical divider member akin to the vertical divider member 310 of the pick cart 300. However, each of the second support members 608 of the exemplary pick cart 600 is implanted in a two-part, book-like form, with a first portion 608a that is oriented vertically and fixedly mounted to the frame 602 such that the first portion 608a is not intended to be moved, and a second portion 608b that is oriented horizontally and coupled to the first portion 608 and/or the frame 602 such that the second portion 608b is permitted to move/pivot upwardly toward the first portion 608a and move-pivot downwardly away from the first portion 608a.

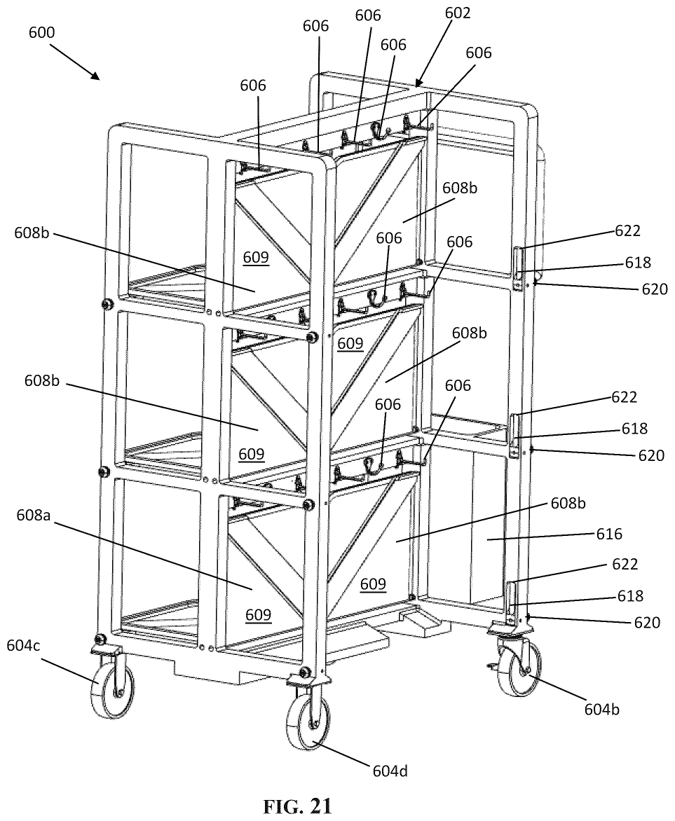

In the illustrated embodiment, the exemplary pick cart 600 includes three rows of first support members 606 and three rows of second support members 608 extending on a first side of the frame. In addition, as can be seen, for example, in FIG. 21, the exemplary pick cart 600 further includes at least three rows of first support members 606 and three rows of second support members 608 extending on a second, opposite, side of the frame 602. In other words, in the embodiment of FIG. 20, the pick cart 600 includes six second support members 608 on one side of the frame 602, and six second support members 608 on an opposite side of the frame 602, such that the pick cart 600 includes twelve second support members 608 in total.

In the exemplary pick cart 600 illustrated in FIG. 20, each row of the first support members 606 includes six first support members 606 (not all of which are identical to one another as mentioned above), and each row of the second support members 608 includes two second support members 608, with three first support members 606 being positioned above each one of the second support members 608. FIG. 20 also shows that, in the exemplary pick cart 600, the first (i.e., top) row of the second support members 608 is located between the first (i.e., top) row and the second (i.e., middle) row of the first support members 606, the second row of the second support members 608 is located between the second (i.e., middle) row and the third (i.e., bottom) row of the first support members 606, and the third (bottom) row of the second support members 608 is located below the third row of the first support members 606.

It will be appreciated, that in some embodiments, the pick cart 600 may include less than three (e.g., one or two) or more than three rows (four, five, six, etc.) rows of first and second support members 606 and 608, and that each of the second support members 608 may have less than three (e.g., one or two) first support members 606, or more than three (four, six, etc.) first support members 606 above it. For example, depending on the size of the pick cart 600, and on the number and size of the first support members 606 and second support members 608, in some embodiments, the pick cart 600 may support from 1 to 48 (or more) product storage bags, for example, 6 product storage bags, 12 product storage bags, 24 product storage bags, 36 product storage bags, 48 product storage bags, 60 product storage bags, 72 product storage bags, etc.

As mentioned above, the second support members 608 include second portions 608b that are movable relative to the first portions 608a and the frame 602, such that each of the second portions 608b of the second support members 608 is permitted to independently pivot upwardly and downwardly relative to the frame 602. For example, in some aspects, each of the second support members 608 is permitted to fold up relative to the frame 602 from a horizontal position shown in FIG. 20 to a vertical position shown in FIG. 21, and to fold back down relative to the frame 602 from the vertical position shown in FIG. 21 back to the horizontal position shown in FIG. 20.

The exemplary pick cart 600 shown in FIGS. 20-21 includes latches 618 that are movably mounted relative to the frame 602. In some embodiments, each of the latches 618 is movable from a horizontal position as shown in FIG. 20 to a vertical position as shown in FIG. 21. When in the horizontal position, each of the latches 618 supports the second portion 608b of a respective one of the second support members 608 when the second portion 608b of the respective one of the second support members 608 is in its initial horizontal position, as shown in FIG. 20. On the other hand, when the second portions 608b of the second support members 608 are in their vertical position as shown in FIG. 21, the latches 618 may be moved to their respective vertical positions as shown in FIG. 21. In certain aspects, each of the latches 618 is operably coupled to a handle or a knob 620, the movement of which (e.g., by the hand of the operator of the pick cart 600) causes a responsive movement of its respective latch 618. For example, in one implementation, clockwise movement of a knob 620 causes the latch 618 to pivot from its horizontal position shown in FIG. 21 to its vertical position shown in FIG. 21.

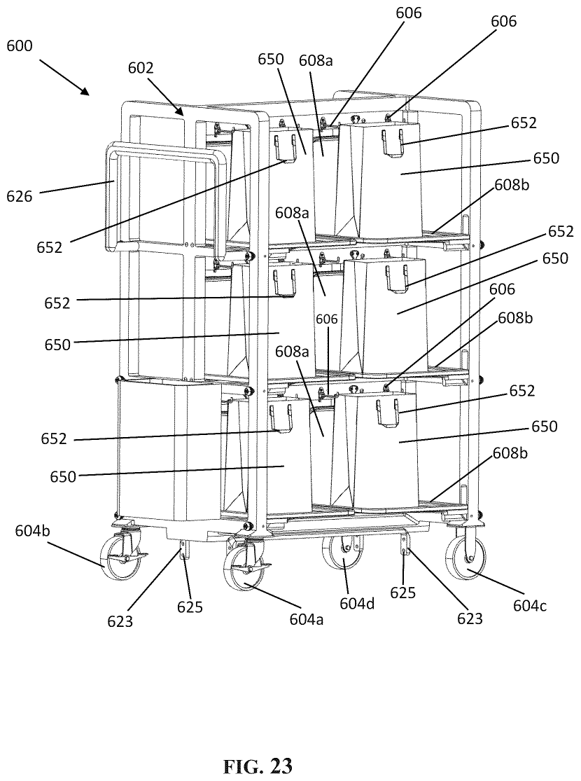

In some embodiments, when each of the second portions 608b of the second support members 608 is in its horizontal position as shown in FIG. 23, each of the second portions 608b of the second support members 608 may support one (or, in some, embodiments, two, three, or more) product storage bags 650 having handles 652 (but which may be lacking the handles 652), such that the bottom of each of the bags 650 is supported on the upwardly-facing surface 607 of a respective second portion 608b of a respective one of the second support members 608. While FIG. 23 does not show the handles 652 of the bags 650 hanging on the first support members 606 of the exemplary pick cart 600, it will be appreciated that the handle or handles 652 of each of the bags 650 may be hanged on one or more first support members 606 located above the second support member 608 on which the bag 650 is located such that the handle or handles 652 are supported by one or two of the respective first support members 606, thereby making the bag 650 more secure on the pick cart 600, and making it less likely that the bag 650 may fall off during movement of the pick cart 600.

As mentioned above, the ability of portions 608b of each of the second support members 608 to pivot/fold upwardly relative to the frame 602 advantageously facilitates both easy placement of bags 650 onto, and easy removal of bags 650 from, the second support members 608 located below second support members 608 that have been folded up. In addition, the ability of the second portions 608b of each of the second support members 608 to pivot/fold upwardly relative to the frame 602 also advantageously enables the pick cart 600 to store both conventional and unconventionally large bags 650. For example, in one aspect, the second portion 608b of the top left second support member 608 may be folded up such that a larger-than-normal bag may be placed on the second portion 608b of the middle left second support member 608. If this larger-than-normal bag 650 includes handles 652, the handles 652 of this bag 650 may be hanged not on one or two of the first support members 606 mounted on an underside 609 of the second portion 608b of the top left second support member 608, but on one or two of the first support members 606 mounted to the frame 602 above the top left second support member 608. In another aspect, the bottom portions 608b of both the top left and the middle left second support members 608 may be folded up such that a larger-than-normal bag 650 may be placed on the second portion 608b of the bottom left second support member 608 and, if this larger-than-normal bag 650 includes handles 652, the handles 652 of this bag 650 may be hanged not on one or two of the second portions 608b of the first support members 606 mounted on an underside 609 of the second portions 608b of the middle or top left second support members 608, but on one or two of the first support members mounted to the frame 602 above the top left second support member 608.

In some embodiments (see FIGS. 20-21), the frame 602 of the pick cart 600 may include recesses, grooves 622 or the like located adjacent each one of the latches 618 and sized and shaped to receive at least a part of the latches 618 when the latches 618 are in their vertical positions. In one aspect, each groove 622 is sized and shaped to fully receive its respective latch 618, such that the entirety of the latch 618 is received within and does not protrude outwardly from its respective groove 622 (see, e.g., FIG. 21). In one embodiment, the downwardly-facing surface 609 of the second portions 608b of each of the second support members 608 may include one or more recesses or grooves akin to the grooves 324 shown in FIG. 8 located adjacent each one of the latches 618, and sized and shaped to receive at least a part of the latches 618 when the latches 618 are in their horizontal positions. In one aspect, each groove 624 is sized and shaped to fully receive its respective latch 618, such that the entirety of the latch 618 may be received within and would not protrude outwardly from its respective groove 624 (see, e.g., FIG. 8).

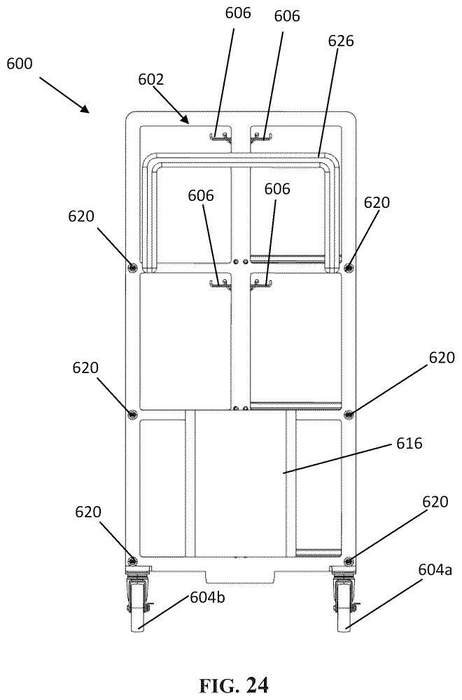

In the embodiment illustrated in FIG. 20 and FIG. 24, the pick cart 600 includes a handlebar 626 mounted to the frame 602 that permits an operator of the pick cart 600 to grasp the handlebar 626 and to push/pull the pick cart 600 via the handlebar 626. In some aspects, the handlebar 626 may be fixedly mounted to the frame 602 of the pick cart 600. In other aspects, the handlebar 626 may be movably/pivotally mounted relative to the frame 602, such that the handlebar 626 may be folded (e.g., by pivoting up or down) when the pick cart 600 is not in use. FIG. 20 also shows that the pick cart 600 includes a bag dispenser 616 coupled to the frame 602 and configured to store a plurality of product storage bags 650 when the product storage bags 650 are not in use.

In some embodiments, the pick cart 600 has four wheels 604a-604d. In one aspect, to improve the maneuverability of the pick cart 600, the two rear wheels 604a and 604b are swivel casters that permit the operator of the cart to complete a full 360-degree rotation of the rear wheels 604a-604b. On the other hand, the two front wheels 604c and 604d may be directional lock casters, which include a locking mechanism (e.g., a stopper, a latch, or the like) that enables the operator of the pick cart 600 to lock the front wheels 604c-604d in any desired position (e.g., straight along the axis of movement of the pick cart 600), preventing the front wheels 604c and 604d from swiveling while locked.

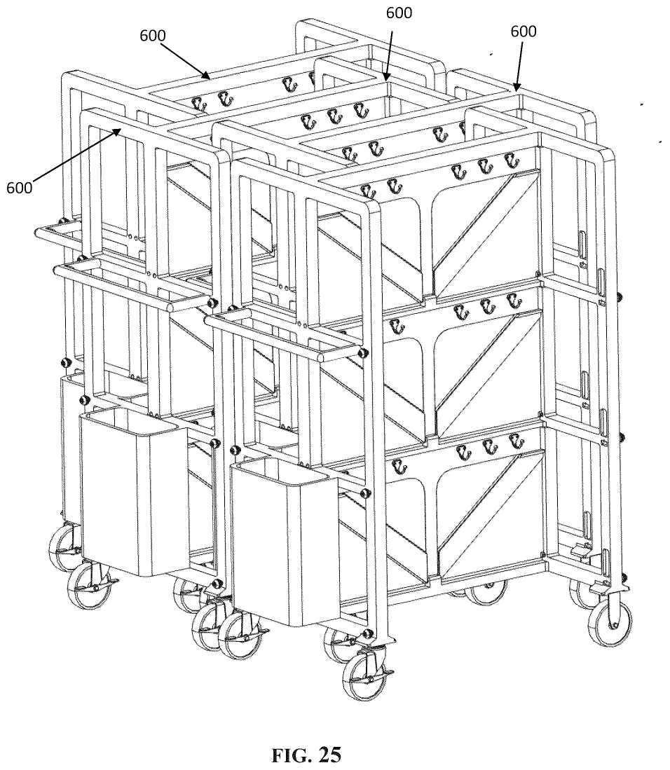

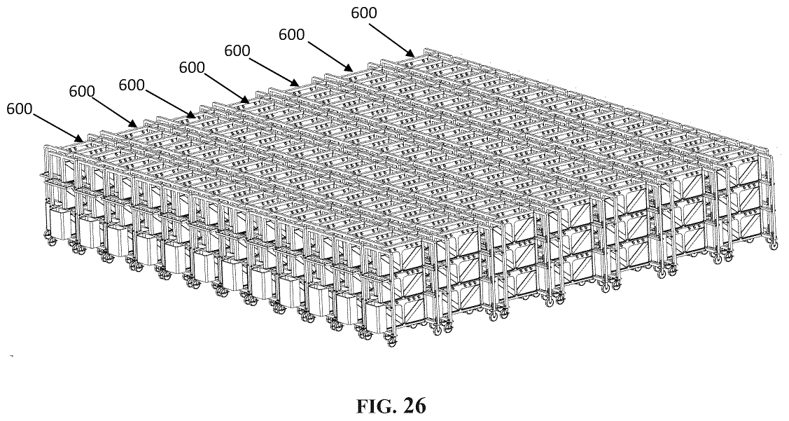

As shown in FIGS. 20 and 21, the frame 602 of the exemplary pick cart 600 is shaped in i-beam form, which enables multiple pick carts 600, after the second support members 608 are folded up (and optionally, after the handle bar 626 is pivoted vertically), to be nested within each other for storage when not in use, thereby advantageously providing a significant savings of the storage space required to store the pick carts 600 while they are not being used. One example of four pick carts 600 positioned in a nested configuration for storage when not in use is illustrated in FIG. 25. An example of over one hundred pick carts 600 positioned in a nested configuration for storage when not in use is illustrated in FIG. 26. As can be clearly seen with reference to FIGS. 25-26, if the pick carts 600 were simply positioned next to each other instead of being partially nested within one another as shown in FIGS. 25-26, the storage space that would be required to accommodate these pick carts 600 would be significantly larger, which would make a big difference for any large-scale product storage facility.

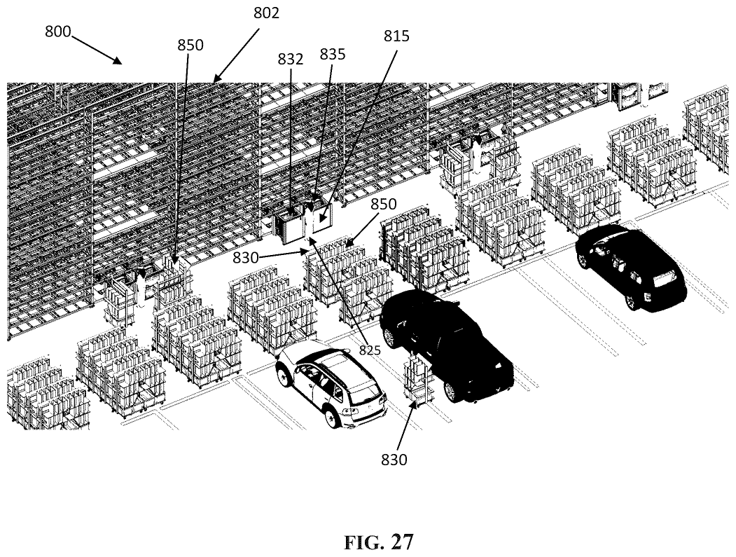

FIG. 27 shows a perspective view of an exemplary embodiment of an automated product storage facility 800 including a product storage structure 782, mobile robots 835 configured to move about the product storage structure 802 while transporting totes 832 and to bring the totes 832 to one or more workstations 815. At the exemplary workstations 815, products/goods may be picked (by a hand of a human operator 825 or an arm of a robot) from totes 832 and placed into bags 850, which may be located at the workstations 815 and/or onto one or more pick carts 830, which may be located adjacent the workstations 815, or stored (if needed, in large quantities) in a nested condition to save storage space nearby the workstations 815. In the embodiment shown in FIG. 27, one of the pick carts 830 is shown next to a vehicle of a customer to illustrate that the pick cart 830 may be moved by the operator 825 (or by a robotic transfer unit, which will be discussed in more detail below) from the workstation 815 to another location inside or outside of the product storage facility, as needed.

In accordance with some embodiments, a non-transitory program storage device readable by a machine may be provided, such as memory, for example, tangibly embodying a program of instructions executable by the machine for performing operations as described in connection with the various embodiments disclosed herein. Any combination of one or more computer readable medium(s) may be utilized as the memory. The computer readable medium may be a computer readable signal medium or a non-transitory computer readable storage medium. A non-transitory computer readable storage medium does not include propagating signals and may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

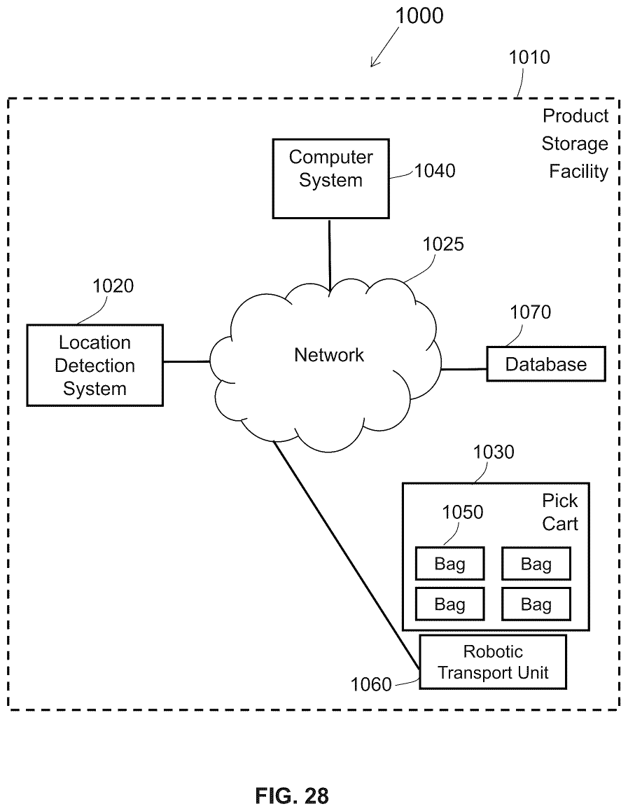

FIG. 28 shows an embodiment of a system 1000 implemented in whole or in part at a product storage facility 1010 for facilitating movement of pick carts 1030 that contain product containing bags 1050. It will be understood that the details of this example are intended to serve in an exemplary capacity and are not necessarily intended to suggest any limitations in regards to the present teachings. Generally, as shown in FIG. 28, the system 1000 includes one or more pick carts 1030 configured to store and move one or more bags 1050 that contain one or more retail products, as well as one or more robotic transport units 1060 configured to mechanically engage (and, optionally, disengage a respective pick cart 1030), a computer system 1040 having at least one control circuit in two-way communication with the robotic transport units 1060; a database 1070, a location detection system 1020, and a network 1025. It is understood that more or fewer of such components may be included in different embodiments of the system 1000.

The product storage facility 1010 may be any facility (e.g., warehouse, stock room of a store, product sorting facility, product distribution facility, or the like) where products are stored and/or sold. While the present application refers to bags 1050 in the context of the objects being moved around on the pick carts 1030, it will be appreciated that the principles described herein are applicable to any structure other than bags 1050 that may contain products and may be moved around on the pick cart 1030 by a robotic transport unit 1060, including but not limited to boxes, totes, bins, packages, or the like. The pick carts 1030 may be moved around the product storage facility 1010 for general order fulfillment purposes, and/or loading/unloading purposes.

Generally, the robotic transport units 1060 are located at the product storage facility 1010 and are configured to move throughout the space of the product storage facility 1010 and to mechanically engage and disengage the pick carts 1030, as described in more detail below. In some embodiments, the robotic transport units 1060 are configured to either comprise, or to selectively and detachably couple to, a corresponding pick cart 1030 that is configured to support one or more bags 1050 that contain one or more products.

The robotic transport units 1060 do not require the presence of and physical operation by a human operator and wirelessly communicate with, and are wholly or largely controlled by, the computer system 1040. In particular, in some embodiments, the computer system 1040 is configured to control movement of the robotic transport units 1060 through the product storage facility 1010 based on a variety of inputs. For example, the computer system 1040 communicates with each robotic transport unit 1060 via the network 1025, which may be one or more wireless networks of one or more wireless network types (such as, a wireless local area network, a wireless personal area network, a wireless mesh network, a wireless star network, a wireless wide area network, a cellular network, and so on), capable of providing wireless coverage of the desired range of the robotic transport units 1060 according to any known wireless protocols, including but not limited to a cellular, Wi-Fi, Zigbee or Bluetooth network.

In the exemplary system 1000 of FIG. 28, the computer system 140 is in two-way communication with the robotic transport units 1060 via a network 1025. In some embodiments, as will be described below, the computer system 1040 is configured to transmit at least one signal to one or more robotic transport units 1060 to cause the robotic transport units 1060 to control their respective pick carts 1030 in order to move bags 1050 (or boxes, totes, etc.) that contain products at the product storage facility 1010.

The computer system 1040 of system 1000 may be a stationary or portable electronic device, for example, a desktop computer, a laptop computer, a tablet, a mobile phone, or any other electronic device including a processor-based control circuit (i.e., control circuit). In the embodiment of FIG. 1, the computer system 1040 is configured for data entry and processing as well as for communication with other devices (e.g., robotic transport units 160) of system 1000 via the network 150 which may be a wide-area network (WAN), a local area network (LAN), a personal area network (PAN), a wireless local area network (WLAN), or any other internet or intranet network, or combinations of such networks. The computer system 1040 may be located at the same physical location as the robotic transport units 160 (i.e., at the product storage facility 110), or at a location remote to the robotic transport units 160 (e.g., a central or regional data storage facility).

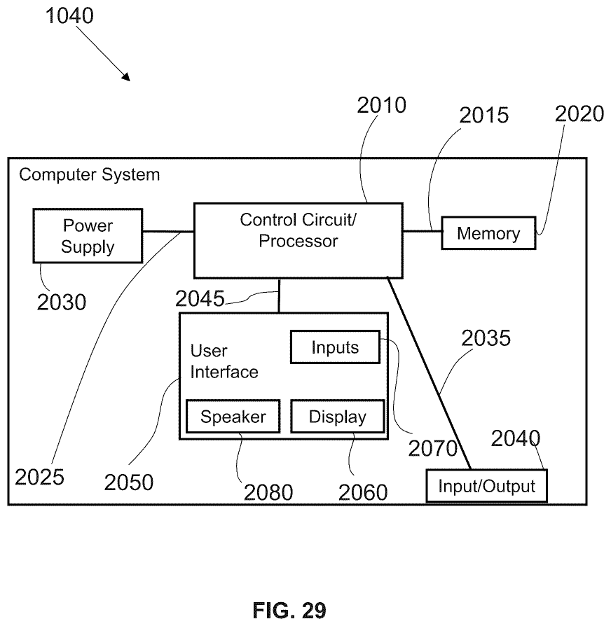

With reference to FIG. 29, the computer system 1040 configured for use with exemplary systems and methods described herein may include a control circuit 2010 including a processor (e.g., a microprocessor or a microcontroller) electrically coupled via a connection 2015 to a memory 2020 and via a connection 2025 to a power supply 2030. The control circuit 2010 can comprise a fixed-purpose hard-wired platform or can comprise a partially or wholly programmable platform, such as a microcontroller, an application specification integrated circuit, a field programmable gate array, and so on. These architectural options are well known and understood in the art and require no further description here.

This control circuit 2010 can be configured (for example, by using corresponding programming stored in the memory 2020 as will be well understood by those skilled in the art) to carry out one or more of the steps, actions, and/or functions described herein. In some embodiments, the memory 2020 may be integral to the processor-based control circuit 2010 or can be physically discrete (in whole or in part) from the control circuit 2010 and is configured non-transitorily store the computer instructions that, when executed by the control circuit 2010, cause the control circuit 2010 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM)) as well as volatile memory (such as an erasable programmable read-only memory (EPROM))). Accordingly, the memory and/or the control circuit may be referred to as a non-transitory medium or non-transitory computer readable medium.

The control circuit 2010 of the computer system 1040 is also electrically coupled via a connection 2035 to an input/output 2040 (e.g., wireless interface) that can receive wired or wireless signals from one or more of the robotic transport units 1060. Also, the input/output 2040 of the computer system 1040 can send signals to the robotic transport units 1060 indicating which location at the product storage facility 110 and/or which worker at the product storage facility 110 to move toward and/or which pick cart 1030 to move toward and/or couple to, where to move the pick cart 1030, and/or where to drop off the pick cart 130.

In the embodiment shown in FIG. 29, the processor-based control circuit 210 of the computer system 1040 is electrically coupled via a connection 2045 to a user interface 2050, which may include a visual display or display screen 2060 (e.g., LED screen) and/or button input 2070 that provide the user interface 2050 with the ability to permit an operator, such as a worker at the product storage facility 1010 where the system 1000 is implemented, of the computer system 1040 to manually control the computer system 1040 by inputting commands via touch-screen and/or button operation and/or voice commands to, for example, to send a signal to a robotic transport unit 1060 to instruct the robotic transport unit 160 to: move underneath a specific pick cart 130 and couple to the pick cart 1030; uncouple from the pick cart 1030; control movement of the pick cart 1030 via the robotic transport unit 1060; move toward a specific physical location and/or toward a specific worker at the product storage facility 1010. It will be appreciated that the performance of such functions by the processor-based control circuit 2010 of the computer system 1040 is not dependent on actions of a human operator, and that the control circuit 2010 may be programmed to perform such functions without being actively controlled by a human operator. The user interface 2050 may also include a speaker 2080 in some aspects.

In some embodiments, the display screen 2060 of the computer system 1040 is configured to display various graphical interface-based menus, options, and/or alerts that may be transmitted from and/or to the computer system 1040 in connection with various aspects of moving pick carts 1030 around the product storage facility 110 via the robotic transport units 1030. The inputs 2070 of the computer system 1040 may be configured to permit an operator to navigate through the on-screen menus on the computer system 1040 and make changes and/or updates to the routes and destinations of the robotic transport units 1060 and/or pick carts 1030 at the product storage facility 110. It will be appreciated that the display screen 2060 may be configured as both a display screen and an input 2070 (e.g., a touch-screen that permits an operator to press on the display screen 2060 to enter text and/or execute commands.)

In some embodiments, the computer system 1040 automatically generates a travel route for one or more robotic transport units 1060 through the space of the product storage facility 1010. In some embodiments, this route is based on a location of a robotic transport unit 1060 and/or a pick cart 1030 and/or the intended destination of the pick cart 1030 and/or locations of structures/obstacles at the product storage facility 110. The computer system 1040 may calculate multiple possible optimum routes. In some embodiments, the system 1000 is capable of integrating 2D and 3D maps of the product storage facility 1010 with physical locations of objects at the product storage facility 1010. Once the computer system 1040 maps all objects to specific locations using algorithms, measurements and LED geo-location, for example, grids are applied which sections off the maps into access ways and blocked sections. Robotic transport units 1060 may use these grids for navigation and recognition. In some embodiments, grids are applied to 2D horizontal maps along with 3D models. In some embodiments, grids start at a higher unit level and then can be broken down into smaller units of measure by the computer system 1040 when needed to provide more accuracy.

In the embodiment shown in FIG. 28, the computer system 1040 is configured to access at least one database 1070. The computer system 1040 and the database 1070 may be implemented as separate physical devices as shown in FIG. 28 (which may be at one physical location or two separate physical locations) or may be implemented as a single device at the product storage facility 1010 (or at a location remote to the product storage facility 1010). In some embodiments, the database 1070 may be stored, for example, on non-volatile storage media (e.g., a hard drive, flash drive, or removable optical disk) internal or external to the computer system 1040, or internal or external to computing devices distinct from the computer system 1040. In some embodiments, the database 1070 is cloud-based.

In some embodiments, the exemplary database 1070 of FIG. 28 is configured to store electronic data including, but not limited to: data associated with the products stored at the product storage facility 1010 (e.g., location of origin of a product destination of the product, storage requirements for the product, special instructions for the product, orders associated with the product, etc.), data associated with the pick carts 130 being used to store and/or move the products (e.g., location of a pick cart 130, destination of the pick cart 1030 as it is being moved by a robotic transport unit 1060, identification of bags 1050 and/or products on the pick cart 1030, etc.); data associated with the robotic transport units 160 being used to control movement of the pick carts 1030 (e.g., location of each robotic transport unit 1060, identification of the pick cart 1030 being controlled by the robotic transport unit 1060, route assigned to the robotic transport unit 1060, etc.); and/or data associated with the computer system 1040 (e.g., data transmitted by and received by the computer system 1040, data relating to the tracking and routing of movement of the robotic transport units and/or pick carts 1030, etc.).

In some embodiments, a location detection system 1020 is provided at the product storage facility 110. The location detection system 1020 provides input to the computer system 1040 useful to help determine the location of one or more of the robotic transport units 160 within the space of the product storage facility 1010.

In some embodiments, the location detection system 1020 includes a series of light sources (e.g., LEDs (light-emitting diodes)) that are mounted at known positions (e.g., in the ceiling) throughout the space of the product storage facility 1010 and that each encode data in the emitted light that identifies the source of the light (and thus, the location of the light). As a given robotic transport unit 1060 or a pick cart 1030 moves through the space of the product storage facility 110, light sensors (or light receivers) on the robotic transport unit 1060 and/or on the pick cart 1030 being transported by the robotic transport unit 1060 receive the light and can decode the data. This data is sent back to the computer system 1040 which can determine the position of the robotic transport unit 1060 and/or of the pick cart 1030 by the data of the light it receives in real time, since the computer system 1040 can relate the light data to a mapping of the light sources to known locations at the product storage facility 1010.

In other embodiments, the location detection system 1020 includes a series of low energy radio beacons (e.g., Bluetooth low energy beacons) at known positions throughout the space of the product storage facility 1010 and that each encode data in the emitted radio signal that identifies the beacon (and thus, the location of the beacon). As a given robotic transport unit 1060 and/or pick cart 1030 moves through the space of the product storage facility 1010, low energy receivers of the robotic transport unit 1060 and/or of the pick cart 1030 being transported by the robotic transport unit 1060 receive the radio signal and can decode the data. This data is sent back to the computer system 1040 which can determine the position of the robotic transport unit 1060 and/or pick cart 1030 by the location encoded in the radio signal it receives, since the computer system 1040 can relate the location data to a mapping of the low energy radio beacons to locations at the product storage facility 1010.

In still other embodiments, the location detection system 1020 includes a series of audio beacons at known positions throughout the space of the product storage facility 1010 and that each encode data in the emitted audio signal that identifies the beacon (and thus, the location of the beacon). As a given robotic transport unit 1060 and/or pick cart 1030 moves through the space, microphones on the robotic transport unit 1060 and/or pick cart 1030 being transported by the robotic transport unit 1060 receive the audio signal and can decode the data. This data is sent back to the computer system 1040 which can determine the position of the robotic transport unit 1060 and/or pick cart 1030 by the location encoded in the audio signal it receives in real time, since the computer system 1040 can relate the location data to a mapping of the audio beacons to known locations at the product storage facility 1010.

In some embodiments, the robotic transport units 1060 and/or the pick carts 1030 may include a global positioning system (GPS) tracking devices that permit a GPS-based identification of the location of the robotic transport units 1060 and/or the pick carts 1030 in real time by the computer system 1040. In some embodiments, the location detection system 1020 of the exemplary system 1000 may include one or more video cameras. Captured video imagery from the video cameras can be provided to the computer system 1040. This information can then serve, for example, to help the computer system 1040 determine a present location of one or more of the robotic transport units 1060 and/or determine issues or concerns regarding automated movement of the robotic transport units 1060 in the space of the product storage facility 1010. For example, such video information can permit the computer system 1040, at least in part, to detect an object in a path of movement of a particular one of the robotic transport units 1060.

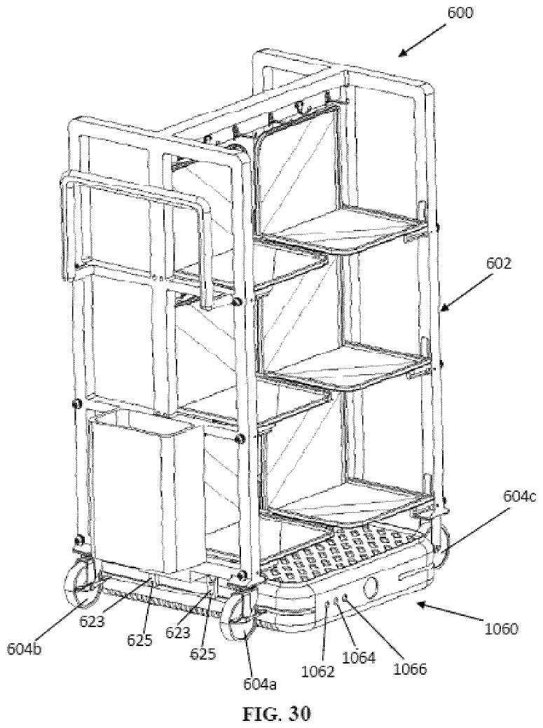

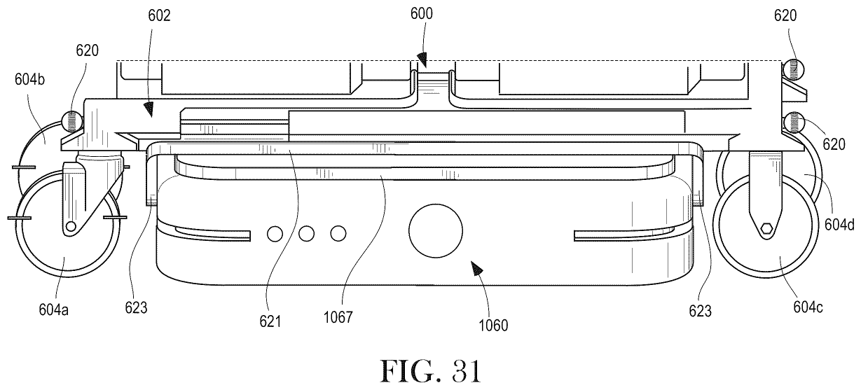

FIGS. 30-31 illustrate an exemplary embodiment of a robotic transport unit 1060 fixedly coupled (i.e., with the intention of not being detachable when in use) to the exemplary pick cart 600 of FIGS. 20-26. In the exemplary embodiment illustrated in FIG. 30, the robotic transport unit 1060 takes the form of a generally rectangular-shaped robotic device, but in other embodiments, the robotic transport unit 1060 may have other shapes and/or configurations, and is not limited to rectangular-shaped. For example, the robotic transport unit 1060 may be disc-shaped, cubic, octagonal, triangular, or other shapes, and may be dependent on the configuration of the pick cart 600 with which the robotic transport unit 1060 is intended to couple.

Notably, the pick cart 600 and/or the robotic transport unit 1060 may include one or more couplings, connectors, guide members, or apertures that may facilitate the coupling of the robotic transport unit 1060 to the pick cart 600. In some aspects, exemplary guide members may be pegs or shafts that extend horizontally along the pick cart 600 and/or the robotic transport unit 1060. In the embodiment illustrated in FIGS. 30-31, the exemplary pick cart 600 includes one or more guide members 621 that facilitate alignment and/or coupling of the pick cart 600 and the robotic transport unit 1060 to each other. The guide member(s) 621 may be mounted to the frame 602 or formed integrally with the frame 602 and may extend horizontally along the length of the pick cart 600 and transverse to the width of the cart.

In the embodiment shown in FIG. 30 and FIG. 31, the pick cart 600 includes two guide members 621, each of which includes a pair of brackets 623 each including one or more apertures 625. The apertures 625 permit one or more fasteners (e.g., bolts, etc.) to pass therethrough, and through (optionally, threaded) complementary openings (not shown) of the robotic transport unit 1060, permitting a secure attachment of the frame 602 of the pick cart 600 to the robotic transport unit 1060. In the embodiment illustrated in FIGS. 30-31, the robotic transport unit 1060 includes a raised flange or ridge 1068 extending along the perimeter of the transport unit 1060 to facilitate the secure attachment of the robotic transport unit 1060 to the pick cart 600, and each of the guide members 621 of the pick cart 600 is securely attached (e.g., welded, etc.) to portions of the raised flange or ridge 1068 of the robotic transport unit 1060.

It will be appreciated that, in some aspects, instead of being directly coupled to, or integrally incorporating the guide members 621, the frame 602 of the pick cart 600 may be directly coupled to, or integrally incorporate one or more pairs of brackets 623 to facilitate a secure, fastener-based attachment of pick cart 600 to robotic transport unit 1060.

In some embodiments, guide members 621 may facilitate the proper alignment of the pick cart 600 and the robotic transport unit 1060. In one embodiment, the pick cart 600 and the robotic transport unit 1060 are properly aligned relative to each other when the apertures 625 of the brackets 623 are aligned with the corresponding fastener-receiving openings of the robotic transport unit 1060. In one implementation, when the robotic transport unit 1060 is in the proper coupling position underneath the pick cart 600 (i.e., when the pick cart 600 and the robotic transport unit 1060 are properly aligned) fasteners (not shown) may be passed through the apertures 625 of the brackets 623 to securely attach the robotic transport unit 1060 to the pick cart 600, thereby enabling the robotic transport unit 1060 to control directional movements of the pick cart 600 attached thereto. In other words, after the robotic transport unit 1060 is in the position shown in FIGS. 30-31, the robotic transport unit 1060 may move about the product storage facility 1010 while transporting the pick cart 600 coupled thereto.

In some aspects, after the robotic transport unit 1060 and the pick cart 600 are securely attached to each other, the robotic transport unit 1060 may receive movement-guiding signals from the computer system 140 and move, in response to these movement-guiding signals about the product storage facility 1010 with the wheels 604a-604d of the pick cart 600 and the wheels (or other locomotory devices) of the robotic transport unit 1060 all remaining on the floor of the product storage facility. In such embodiments, the robotic transport unit 1060 does not bear the full weight of the pick cart 600, since the wheels of the pick cart 600 rest on the floor.

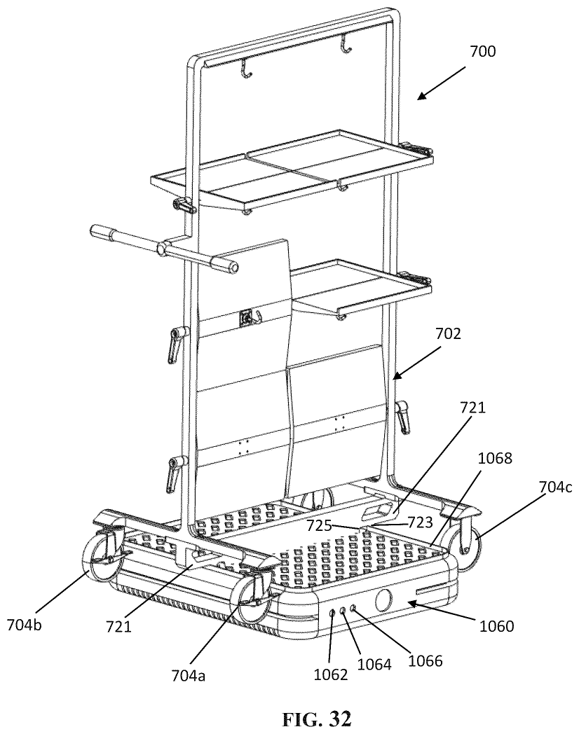

FIG. 31. and FIG. 32 illustrates an exemplary embodiment of the robotic transport unit 1060 detachably coupled (i.e., with the intention of being detachable when in use) to a pick cart 700 according to an exemplary embodiment, which is similar to the pick cart 600 of FIGS. 20-26. As mentioned above, in some embodiments, the exemplary robotic transport unit 1060 may include one or more sensors 1062 that indicate the position of the robotic transport unit 1060 and/or facilitate the docking of the robotic transport unit 1060 to the pick cart 700. In certain aspects, the robotic transport unit 1060 may further include one or more sensors 1064 configured to receive a light source (or sound waves) emitted from light sources (or sound sources) around the product storage facility 1010, and thus facilitate the determination of the location of the robotic transport unit 1060 via the location detection system 1020 by the computer system 1040. In some aspects, instead of or in addition to the location/docking sensors 1062 and 1064, the robotic transport unit 1060 may further include a beacon 1066 as described above that facilitates the determination of the location of the robotic transport unit 1060 via the location detection system 1020 by the computer system 1040.

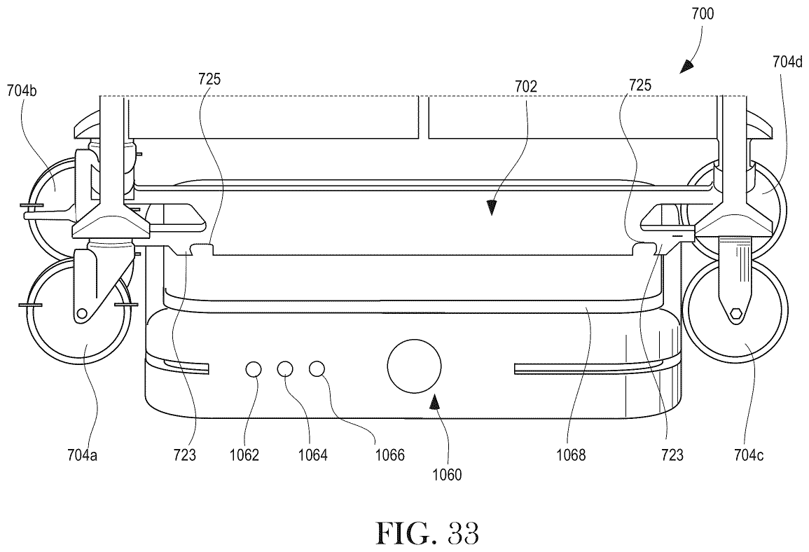

Notably, the pick cart 700 and/or the robotic transport unit 1060 may include one or more couplings, connectors, guide members, or apertures that may facilitate the coupling of the robotic transport unit 1060 to the pick cart 700. As pointed out above, exemplary guide members may be pegs or shafts that extend horizontally along the pick cart 700 and/or the robotic transport unit 1060. Unlike the pick cart 600 illustrated in FIGS. 30-31, which includes two guide members 621, the exemplary pick cart 700 illustrated in FIGS. 32-33, includes one guide member 721 that facilitates alignment and/or coupling of the pick cart 700 and the robotic transport unit 1060 to each other. The guide member 721 may be mounted to the frame 702 of the pick cart 700, or formed integrally with the frame 702, and may extend horizontally along the length of the pick cart 700 and transverse to the width of the pick cart 700. In some embodiments, the pick cart 700 may include two or more guide members 721 instead of one.

In the embodiment shown in FIGS. 32-33, the pick cart 700 includes two hook members 723 proximate opposite ends thereof. In the illustrated embodiment, the guide member further includes a cutout 725 located adjacent each of the hook members 723. As mentioned above, in the illustrated embodiment, the robotic transport unit 1060 includes a raised flange or ridge 1068 extending along the perimeter of the transport unit 1060 to facilitate the secure attachment of the robotic transport unit 1060 to the pick cart 600. In the embodiment illustrated in FIGS. 32-33, the raised ridge 1068 provides a structure that can be tightly grasped by one or more of the hook members 723 of the guide member 721 of the pick cart 700, thereby providing a secure attachment of the pick cart 700 to the robotic transport unit 1060.

In some embodiments, the guide member 721 may facilitate the proper alignment of the pick cart 700 and the robotic transport unit 1060. In one embodiment, the pick cart 700 and the robotic transport unit 1060 are properly aligned relative to each other when the robotic transport unit 1060 is positioned underneath the pick cart 700 such that portions of the ridge 1068 of the robotic transport unit 1060 are received in the cutouts 725 of the guide member 721, and at least one of the hook members 723 grasps the ridge 1068 of the robotic transport unit 1060 as shown in FIG. 33. Notably, while FIG. 33 shows only one of the hook members 723 grasping the ridge 1068 of the robotic transport unit 1060, it will be appreciated that, in some embodiments, the pick cart 700 may securely (albeit) detachably attach to the robotic transport unit 1060 by way of both hook members 723 grasping respective portions of the ridge 1068 of the robotic transport unit 1060. In one implementation, when the robotic transport unit 1060 and the pick cart 700 are properly aligned and securely attached to each other as shown in FIGS. 32-33, the robotic transport unit 1060 is able to move about the product storage facility 1010 while controlling directional movements of the pick cart 700 attached thereto.

In some aspects, after the robotic transport unit 1060 and the pick cart 700 are securely attached to each other, the robotic transport unit 1060 may receive movement-guiding signals from the computer system 140 and move, in response to these movement-guiding signals about the product storage facility 1010.

In some embodiments, after the robotic transport unit 1060 is in the correct and properly aligned position underneath the pick cart 700 (e.g., the correct position of the robotic transport unit 1060 may be determined, for example, via the 1062 of the robotic transport unit 1060), the motorized transport unit 1060 may lift up or otherwise expand (e.g., via hydraulics, expandable members, or the like) such that the robotic transport unit 1060 rises to a greater height relative to the floor on which the wheels 704a-704d of the pick cart 700 are located, and such that the wheels 704a-704d are lifted up off the floor by the robotic transport unit 1060, with the wheels (or other locomotory devices) of the motorized transport unit 1060 remaining on the ground. As such, the robotic transport unit 1060 is able to move the pick cart 700 throughout the space of the product storage facility 1010 with the wheels 704a-704d of the pick cart 700 being off the floor while the wheels of the robotic transport unit 1060 are in contact with the floor of the product storage facility 1010. In such embodiments, the robotic transport unit 1060 bears the full weight of the pick cart 700, since the wheels of the pick cart 700 are off the floor.

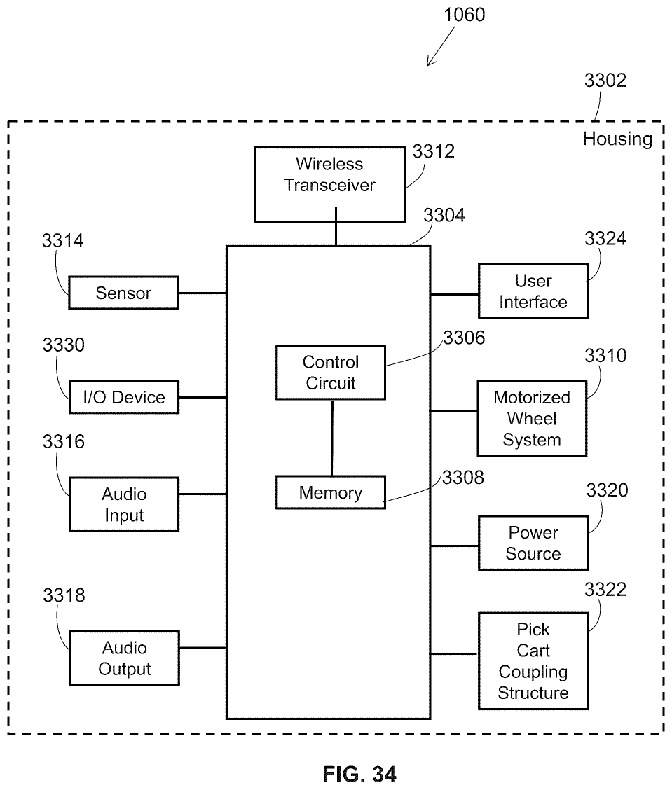

FIG. 34 presents a detailed schematic example of some embodiments of the robotic transport unit 1060 of FIGS. 30-33. In this example, the robotic transport unit 1060 has a housing 3302 that contains (partially or fully) or at least supports and carries a number of components. These components include a control circuit 3304 comprising a control circuit 3306 that, like the control circuit 2010 of the computer system 1040, controls the general operations of the robotic transport unit 1060. Accordingly, the control circuit 3304 also includes a memory 3308 coupled to the control circuit 3306 and that stores, for example, operating instructions and/or useful data.

The control circuit 3306 operably couples to a motorized wheel system 3310. This motorized wheel system 3310 functions as a locomotion system to permit the robotic transport unit 1060 to move within the aforementioned product storage facility 1010 (thus, the motorized wheel system 3310 may more generically be referred to as a locomotion system). Generally, this motorized wheel system 3310 will include at least one drive wheel (i.e., a wheel that rotates (around a horizontal axis) under power to thereby cause the robotic transport unit 1060 to move through interaction with, for example, the floor of the product storage facility 1010). The motorized wheel system 3310 can include any number of rotating wheels and/or other floor-contacting mechanisms as may be desired and/or appropriate to the application setting. The motorized wheel system 3360 may also include a steering mechanism of choice. One simple example may comprise one or more wheels that can swivel about a vertical axis to thereby cause the moving robotic transport unit 1060 to turn as well. Various examples of motorized wheel systems are known in the art. Further elaboration in these regards is not provided here for the sake of brevity save to note that the aforementioned control circuit 3306 is configured to control the various operating states of the motorized wheel system 3310 to thereby control when and how the motorized wheel system 3310 operates.

In the exemplary embodiment of FIG. 34, the control circuit 3306 operably couples to at least one wireless transceiver 3312 that operates according to any known wireless protocol. This wireless transceiver 3312 can comprise, for example, a Wi-Fi-compatible and/or Bluetooth-compatible transceiver that can wirelessly communicate with the aforementioned computer system 1040 via the aforementioned network 1025 of the product storage facility 1010. So configured, the control circuit 3306 of the robotic transport unit 1060 can provide information to the computer system 1040 (via the network 1025) and can receive information and/or movement instructions (instructions from the computer system 1040.

For example, the control circuit 3306 can receive instructions from the computer system 1040 via the network 1025 regarding directional movement (e.g., specific predetermined routes of movement) of the robotic transport unit 1060 when coupled to a pick cart 1030 throughout the space of the product storage facility 1010. These teachings will accommodate using any of a wide variety of wireless technologies as desired and/or as may be appropriate in a given application setting. These teachings will also accommodate employing two or more different wireless transceivers 3312, if desired.

The control circuit 3306 also couples to one or more on-board sensors 3314. These teachings will accommodate a wide variety of sensor technologies and form factors. By one approach, at least one such sensor 3314 can comprise a light sensor or light receiver. When the aforementioned location detection system 1020 comprises a plurality of light emitters disposed at particular locations within the product storage facility 1010, such a light sensor 3314 can provide information that the control circuit 3306 and/or the computer system 1040 employs to determine a present location and/or orientation of the robotic transport unit 360 within the space of the product storage facility 1010.

As another example, such a sensor 3314 can comprise a distance measurement unit configured to detect a distance between the robotic transport unit 1060 and one or more objects or surfaces around the robotic transport unit 1060 (such as an object that lies in a projected path of movement for the robotic transport unit 1060 through the product storage facility 1010). These teachings will accommodate any of a variety of distance measurement units including optical units and sound/ultrasound units. In one example, a sensor 3314 comprises a laser distance sensor device capable of determining a distance to objects in proximity to the sensor. In some embodiments, a sensor 3314 comprises an optical based scanning device to sense and read optical patterns in proximity to the sensor.

In some embodiments, a sensor 3314 comprises a radio frequency identification (RFID) tag reader capable of reading RFID tags in proximity to the sensor. Such sensors may be useful to determine proximity to nearby objects, avoid collisions, orient the robotic transport unit 1060 at a proper alignment orientation to engage, for example, a pick cart 1030 or the like. The foregoing examples are intended to be illustrative and are not intended to convey an exhaustive listing of all possible sensors. Instead, it will be understood that these teachings will accommodate sensing any of a wide variety of circumstances or phenomena to support the operating functionality of the robotic transport unit 1060 in a given application setting.

In some embodiments, a robotic transport unit 1060 may detect objects along their path of travel using, for example, sensors mounted on robotic transport unit 1060 and/or video cameras or other sensors/readers installed at the product storage facility 1010, and/or sensors installed on the robotic transport unit 1060, and/or via communications with the computer system 1040. In some embodiments, the robotic transport unit 1060 may attempt to avoid obstacles, and if unable to avoid, it will notify the computer system 1040 of such a condition. In some embodiments, using sensors 3314 (such as distance measurement units, e.g., laser or other optical-based distance measurement sensors), the robotic transport unit 1060 detects obstacles in its path, and will move to avoid, or stop until the obstacle is clear.

By one optional approach, an audio input 3316 (such as a microphone) and/or an audio output 3318 (such as a speaker) can also operably couple to the control circuit 3306. So configured, the control circuit 3306 can provide a variety of audible sounds to thereby communicate with a user (e.g., a worker at the product storage facility 1010) of the robotic transport unit 1060 or other robotic transport units 1060 in the area. These audible sounds can include any of a variety of tones and other non-verbal sounds. Such audible sounds can also include, in lieu of the foregoing or in combination therewith, pre-recorded or synthesized speech.

The audio input 3316, in turn, provides a mechanism whereby, for example, a user (e.g., a worker at the product storage facility 1010) provides verbal input to the control circuit 3306. That verbal input can comprise, for example, instructions, inquiries, or information. So configured, a user can provide, for example, an instruction and/or query to the robotic transport unit 1060. The control circuit 3306 can cause that verbalized question to be transmitted to the computer system 1040 via the wireless transceiver 3312 of the robotic transport unit 1060. The computer system 1040 can process that verbal input to recognize the speech content and to then determine an appropriate response. Such a response might comprise, for example, transmitting back to the robotic transport unit 1060 specific instructions regarding how to move (i.e., a specific route calculated by the computer system 1040) the robotic transport unit 1060 (via the aforementioned motorized wheel system 3310) to the location in the product storage facility 1010 where a given pick cart 1030 is located.

In the embodiment illustrated in FIG. 34, the robotic transport unit 1060 includes a rechargeable power source 3320 such as one or more batteries. The power provided by the rechargeable power source 3320 can be made available to whichever components of the robotic transport unit 1060 require electrical energy. By one approach, the robotic transport unit 1060 includes a plug or other electrically conductive interface that the control circuit 3006 can utilize to automatically connect to an external source of electrical energy to thereby recharge the rechargeable power source 3320.

By one approach, the robotic transport unit 1060 comprises an integral part of the pick cart 1030. As used herein, this reference to “integral” will be understood to refer to a non-temporary combination and joinder that is sufficiently complete so as to consider the combined elements to be as one. Such a joinder can be facilitated in a number of ways including by securing the robotic transport unit housing 3302 to the pick cart 1030 using bolts or other threaded fasteners as versus, for example, a clip.

In some embodiments, the robotic transport unit 1060 includes an input/output (I/O) device 3330 that is coupled to the control circuit 3306. The I/O device 3330 allows an external device to couple to the control circuit 3304. The function and purpose of connecting devices will depend on the application. In some examples, devices connecting to the I/O device 3330 may add functionality to the control circuit 3304, allow the exporting of data from the control circuit 3304, allow the diagnosing of the robotic transport unit 1060, and so on.

In some embodiments, the robotic transport unit 1060 includes a user interface 3324 including for example, user inputs and/or user outputs or displays depending on the intended interaction with the user (e.g., worker at product storage facility 1010). For example, user inputs could include any input device such as buttons, knobs, switches, touch sensitive surfaces or display screens, and so on. Example user outputs include lights, display screens, and so on. The user interface 3326 may work together with or separate from any user interface implemented at an optional user interface unit (such as a smart phone or tablet device) usable by a worker at the product storage facility 1010.

In some embodiments, the robotic transport unit 1060 may be controlled by a user on-site, off-site, or anywhere in the world. This is due to the architecture of some embodiments where the computer system 1040 outputs the control signals to the robotic transport unit 160. These controls signals can originate at any electronic device in communication with the computer system 1040. For example, the movement signals sent to the robotic transport unit 1060 may be movement instructions determined by the computer system 1040; commands received at a user interface unit from a user; and commands received at the computer system 1040 from a remote user not located at the product storage facility 1010.

The control circuit 3304 includes a memory 3308 coupled to the control circuit 3306 and that stores, for example, operating instructions and/or useful data. The control circuit 3306 can comprise a fixed-purpose hard-wired platform or can comprise a partially or wholly programmable platform. These architectural options are well known and understood in the art and require no further description here. This control circuit 3306 is configured (for example, by using corresponding programming stored in the memory 3308 as will be well understood by those skilled in the art) to carry out one or more of the steps, actions, and/or functions described herein. The memory 3308 may be integral to the control circuit 3306 or can be physically discrete (in whole or in part) from the control circuit 3306 as desired. This memory 3308 can also be local with respect to the control circuit 3306 (where, for example, both share a common circuit board, chassis, power supply, and/or housing) or can be partially or wholly remote with respect to the control circuit 3306. This memory 3308 can serve, for example, to non-transitorily store the computer instructions that, when executed by the control circuit 3306, cause the control circuit 3306 to behave as described herein.

It is noted that not all components illustrated in FIG. 34 are included in all embodiments of the robotic transport unit 1060. That is, some components may be optional depending on the implementation.

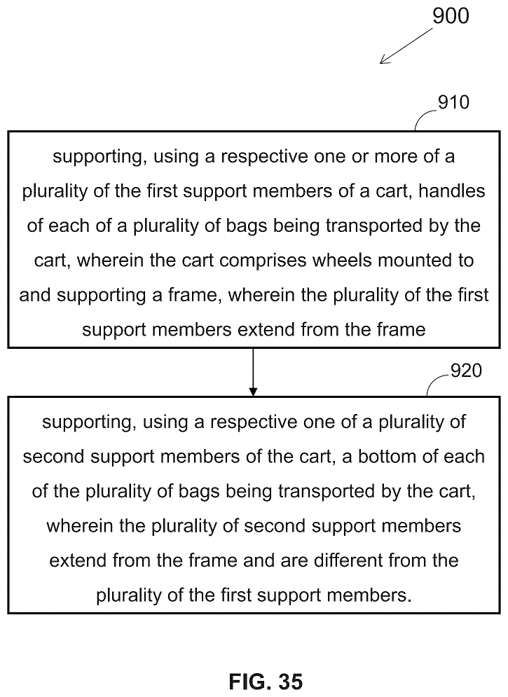

FIG. 35 illustrates an exemplary method 900 of transporting a plurality of bags 650. The method 900 includes supporting, using a respective one or more of a plurality of the first support members 606 of a cart, handles 652 of each of a plurality of bags 650 being transported by the cart 600, wherein the cart 600 comprises wheels 604a-604d mounted to and supporting a frame 602, and wherein the plurality of the first support members 606 extend from the frame 602 (step 910). In addition, the method 900 further includes supporting, using a respective one of a plurality of second support members 608 of the cart 600, a bottom of each of the plurality of bags 650 being transported by the cart 600, wherein the plurality of second support members 608 extend from the frame 602 and are different from the plurality of the first support members 606 (step 920).

Several embodiments of carts for transporting product-containing bags and associated methods are described herewith.

In some embodiments, a cart for transporting a plurality of bags for use in a product storage facility comprises a frame; wheels mounted to and supporting the frame; a plurality of first support members extending from and fixedly mounted relative to the frame and configured to support handles of the bags thereon; and a plurality of second support members movably mounted relative to the frame and configured to support a bottom of the bags thereon; wherein the first support members are different from the second support members.

In some embodiments, a method of transporting a plurality of bags about a product storage facility comprises: supporting, using a respective one or more of a plurality of the first support members of a cart, handles of each of a plurality of bags being transported by the cart, wherein the cart comprises wheels mounted to and supporting a frame, wherein the plurality of the first support members extend from the frame; and supporting, using a respective one of a plurality of second support members of the cart, a bottom of each of the plurality of bags being transported by the cart, wherein the plurality of second support members extend from the frame and are different from the plurality of the first support members.

The foregoing detailed description has been presented for purposes of illustration and description and is not intended to be exhaustive or to limit the description to the precise form disclosed. Many modifications and variations are possible in light of the above teaching. The described embodiments were chosen in order to best explain the principles of the claimed devices and systems and their practical applications to thereby enable others skilled in the art to best utilize the claimed devices and system in various embodiments and with various modifications as are suited to the particular use contemplated. It is intended that the scope of the method be defined by the claims appended hereto.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

1. A cart for transporting a plurality of bags for use in a product storage facility, the cart comprising:
a frame,
wheels mounted to and supporting the frame;
a plurality of first support members extending from and fixedly mounted relative to the frame and configured to support handles of the bags thereon; and
a plurality of second support members movably mounted relative to the frame and configured to support a bottom of the bags thereon;
wherein the first support members are different from the second support members.

2. The cart of claim 1, wherein each of the first support members comprises a hook, and wherein each of the second support members comprises a tray or a shelf.

3. The cart of claim 1, wherein the frame comprises a vertical divider member, wherein some of the second support members extend away from one side of the vertical divider member and some of the second support members extend away from an opposite side of the vertical divider member.

4. The cart of claim 3, wherein the second support members are pivotally coupled relative to the vertical divider member such that each of the second support members is permitted to fold up relative to the vertical divider member.

5. The cart of claim 4, wherein the frame is in a form of an i-beam, and wherein, after the second support members are folded up, the cart permits another identical cart having second support members folded up to be nested thereagainst.

6. The cart of claim 3, wherein the cart includes at least three rows of first support members and three rows of second support members extending on a first side of the vertical divider member, and further comprising at least three rows of first support members and three rows of second support members extending on a second, opposite, side of the vertical divider member.

7. The cart of claim 6, wherein:
a first row of the second support members is located between first and second rows of the first support members;
a second row of the second support members is located between second and third rows of the first support members; and
a third row of the second support members is located below a third row of the first support members.

8. The cart of claim 6, wherein at least one pair of the first support members is positioned above each one of the second support members.

9. The cart of claim 1, further comprising a bag dispenser coupled to the frame and configured to store a plurality of the bags when the bags are not in use.

10. The cart of claim 1, further comprising at least one robotic transport unit including a processor-based control circuit and configured to mechanically engage the cart, and to move the cart about the product storage facility when mechanically engaged to the cart.

11. A method of transporting a plurality of bags in a product storage facility, the method comprising:
supporting, using a respective one or more of a plurality of first support members of a cart, handles of each of a plurality of bags being transported by the cart, wherein the cart comprises wheels mounted to and supporting a frame, wherein the plurality of the first support members extend from the frame; and
supporting, using a respective one of a plurality of second support members of the cart, a bottom of each of the plurality of bags being transported by the cart, wherein the plurality of second support members extend from the frame and are different from the plurality of the first support members.

12. The method of claim 11, wherein each of the first support members comprises a hook, and wherein each of the second support members comprises a tray or a shelf.

13. The method of claim 11, wherein the frame comprises a vertical divider member, wherein some of the second support members extend away from one side of the vertical divider member and some of the second support members extend away from an opposite side of the vertical divider member.

14. The method of claim 13, wherein the second support members are pivotally coupled relative to the vertical divider member such that each of the second support members is permitted to fold up relative to the vertical divider member.

15. The method of claim 14, wherein the frame is in a form of an i-beam, and wherein, after the second support members are folded up, the cart permits another identical cart having second support members folded up to be nested thereagainst.

16. The method of claim 13, wherein the cart includes at least three rows of first support members and three rows of second support members extending on a first side of the vertical divider member, and further comprising at least three rows of first support members and three rows of second support members extending on a second, opposite, side of the vertical divider member.

17. The method of claim 16, wherein:
a first row of the second support members is located between first and second rows of the first support members;
a second row of the second support members is located between second and third rows of the first support members; and
a third row of the second support members is located below a third row of the first support members.

18. The method of claim 16, wherein at least one pair of the first support members is positioned above each one of the second support members.

19. The method of claim 11, further comprising a bag dispenser coupled to the frame and configured to store a plurality of the bags when the bags are not in use.

20. The method of claim 11, further comprising at least one robotic transport unit including a processor-based control circuit and configured to mechanically engage the cart, and to move the cart about the product storage facility when mechanically engaged to the cart.
